(19) United States
(12) Patent Application Publication
(10) Pub. No.: US 2022/0312201 A1
(43) Pub. Date: Sep. 29, 2022

(54) INFORMATION PROCESSING DEVICE, SERVER DEVICE, INFORMATION TERMINAL, AND INFORMATION PROCESSING SYSTEM

(71) Applicant: SONY GROUP CORPORATION, TOKYO (JP)

(72) Inventor: YUJI KAMEDA, TOKYO (JP)

(21) Appl. No.: 17/642,468

(22) PCT Filed: Sep. 4, 2020
(86) PCT No.: PCT/JP2020/033553

§ 371 Date: Mar. 11, 2022

(30) Foreign Application Priority Data
Sep. 20, 2019 (JP) 2019-171459

(51) Int. Cl. H04W 12/06; H04W 8/18

(52) U.S. Cl. CPC H04W 12/06; H04W 8/183; H04W 84/12

(57) ABSTRACT

The present technology relates to an information processing device, a server device, an information terminal, and an information processing system capable of providing a highly secure network connection environment. Personal information for specifying a user is acquired, terminal information for specifying a communication terminal used by the user is acquired, identification information or a medium storing the identification information is issued, and the personal information, the terminal information, and the identification information are transmitted to a server device. The present technology can be applied to, for example, an information processing system that constructs a service for providing connection to the Internet using Wi-Fi (public wireless LAN).

### TECHNICAL FIELD

The present technology relates to an information processing device, a server device, an information terminal, and an information processing system, and particularly relates to an information processing device, a server device, an information terminal, and an information processing system that provide a highly secure network connection environment.

### BACKGROUND ART

Various methods have been proposed for connecting a user's own communication terminal (simply referred to as a terminal) to a public network such as a public wireless LAN when the user uses the network (see Patent Documents 1 to 5).

### CITATION LIST

### Patent Document

### Patent Document 1: Japanese Patent Application Laid-Open No. 2015-139104

### Patent Document 2: Japanese Patent Application Laid-Open No. 2016-1496

### Patent Document 3: Japanese Patent Application Laid-Open No. 2015-126452

### Patent Document 4: Japanese Patent No. 4774823

### Patent Document 5: Japanese Patent Application Laid-Open No. 2017-147536

### SUMMARY OF THE INVENTION

### Problems to be Solved by the Invention

The public network is used by an unspecified large number of users, and thus has low security.

The present technology has been made in view of such a situation, and provides a highly secure network connection environment.

### Solutions to Problems

An information processing device according to one aspect of the present technology is an information processing device including: a personal information acquisition unit configured to acquire personal information for specifying a user; a terminal information acquisition unit configured to acquire terminal information for specifying a communication terminal used by the user; an issuing unit configured to issue identification information or a medium storing the identification information; and a communication unit configured to transmit the personal information, the terminal information, and the identification information to a server device.

In the information processing device according to one aspect of the present technology, the personal information for specifying the user is acquired, the terminal information for specifying the communication terminal used by the user is acquired, the identification information or the medium storing the identification information is issued, and the personal information, the terminal information, and the identification information are transmitted to the server device.

A server device according to one aspect of the present technology is a server device including: a user information storage unit configured to store personal information of a user, terminal information of a communication terminal used by the user, and identification information issued to the user in association with each other; and a communication unit configured to communicate with an external information device, in which the communication unit transmits at least one of the personal information or the terminal information in the user information storage unit to the external information device, the personal information and the terminal information being associated with the identification information given from the external information device.

In the server device according to one aspect of the present technology, the personal information of the user, the terminal information of the communication terminal used by the user, and the identification information issued to the user are stored in association with each other, communication is performed with the external information device, at least one of the personal information or the terminal information in the user information storage unit is transmitted to the external information device, and the personal information and the terminal information are associated with the identification information given from the external information device.

An information terminal according to one aspect of the present technology is an information terminal including: an identification information acquisition unit configured to acquire identification information issued to a user; a communication unit configured to transmit the identification information to a server device and to receive terminal information of a communication terminal of the user, the terminal information being associated with the identification information; and a wireless communication unit configured to perform wireless communication with the communication terminal of the user by wireless connection on the basis of the terminal information.

In the information terminal according to one aspect of the present technology, the identification information issued to the user is acquired, the identification information is transmitted to the server device, the terminal information of the communication terminal of the user, which is associated with the identification information, is received, and the information terminal is connected to the communication terminal of the user by wireless communication on the basis of the terminal information.

An information processing system according to one aspect of the present technology is an information processing system including: a personal information acquisition unit configured to acquire personal information for specifying a user; a terminal information acquisition unit configured to acquire terminal information for specifying a communication terminal used by the user; an issuing unit configured to issue identification information or a medium storing the identification information; a storage unit configured to store the personal information, the terminal information, and the identification information in association with each other; an identification information acquisition unit configured to acquire the identification information issued by the issuing unit or the identification information stored in the medium issued by the issuing unit; a terminal information acquisition unit configured to acquire, from the storage unit, the terminal information associated with the identification information acquired by the identification information acquisition unit; and a communication unit configured to connect the communication terminal specified by the terminal information acquired by the terminal information acquisition unit to a network via wireless connection.

In the information processing system according to one aspect of the present technology, the personal information for specifying the user is acquired, the terminal information for specifying the communication terminal used by the user is acquired, the identification information or the medium storing the identification information is issued, the personal information, the terminal information, and the identification information are stored in association with each other, the issued identification information or the identification information stored in the issued medium is acquired, the terminal information associated with the acquired identification information is acquired, and the communication terminal specified by the acquired terminal information is connected to the network via wireless connection.

### BRIEF DESCRIPTION OF DRAWINGS

FIG. 1 is a block diagram illustrating a schematic configuration example of a first embodiment of an information processing system to which the present technology is applied.

FIG. 2 is a diagram for describing an appearance of an IC card issuing machine and a flow up to issuance of an IC card.

FIG. 3 is a sequence diagram for describing processing of a user, a terminal, the IC card issuing machine, and an authentication server at the time of issuing the IC card.

FIG. 4 is a diagram for describing an appearance of a Wi-Fi spot and a flow from issuance of the IC card to start of use of a public wireless LAN.

FIG. 5 is a sequence diagram for describing processing of the user, the terminal, the Wi-Fi spot, and the authentication server at the start of use of the public wireless LAN.

FIG. 6 is a diagram exemplifying an information screen displayed on a display of the terminal when a Wi-Fi connection between the terminal and the Wi-Fi spot is established.

FIG. 7 is a block diagram for describing a configuration example of an IC card issuing machine 13.

FIG. 8 is a flowchart for describing an example of processing related to a user interface of the IC card issuing machine in FIG. 7 at the time of issuing the IC card.

FIG. 9 is a diagram exemplifying a selection screen displayed on the display in step S81 of FIG. 8.

FIG. 10 is a diagram exemplifying an induction screen displayed on the display in step S83 of FIG. 8.

FIG. 11 is a diagram exemplifying an induction screen displayed on the display in step S85 of FIG. 8.

FIG. 12 is a diagram exemplifying a confirmation screen displayed on the display in step S87 of FIG. 8.

FIG. 13 is a diagram exemplifying an induction screen displayed on the display in step S89 of FIG. 8.

FIG. 14 is a diagram exemplifying a Wi-Fi connection setting screen displayed on the display of the terminal in step S90 of FIG. 8.

FIG. 15 is a diagram exemplifying a confirmation screen displayed on the display in step S92 of FIG. 8.

FIG. 16 is a diagram exemplifying a notification screen displayed on the display in step S94 of FIG. 8.

FIG. 17 is a block diagram illustrating a configuration example of the Wi-Fi spot.

FIG. 18 is a flowchart for describing an example of processing related to a user interface of the Wi-Fi spot at the start of use of the public wireless LAN.

FIG. 19 is a diagram exemplifying a touch frame portion over which the user holds the IC card in step S151 of FIG. 18.

FIG. 20 is a diagram exemplifying the touch frame portion.

FIG. 21 is a diagram exemplifying a Wi-Fi connection setting screen displayed on the display of the terminal in step S156 of FIG. 18.

FIG. 22 is a block diagram for describing a configuration example of the authentication server.

FIG. 23 is a flowchart for describing an example of processing of the authentication server.

FIG. 24 is a block diagram illustrating a schematic configuration example of a second embodiment of the information processing system to which the present technology is applied.

FIG. 25 is a diagram for describing a flow of processing at the time of issuing a two-dimensional code.

FIG. 26 is a diagram for describing a flow of processing at the time of issuing an IC card using the two-dimensional code.

FIG. 27 is a block diagram for describing a configuration example of a two-dimensional code issuing machine.

FIG. 28 is a block diagram for describing a configuration example of an IC card issuing machine using the two-dimensional code.

FIG. 29 is a flowchart for describing an example of processing related to a user interface of the two-dimensional code issuing machine at the time of issuing the two-dimensional code.

FIG. 30 is a diagram exemplifying a start screen displayed on a display in step S301 of FIG. 29.

FIG. 31 is a diagram exemplifying an induction screen displayed on the display in step S302 of FIG. 29.

FIG. 32 is a diagram exemplifying a confirmation screen displayed on the display in step S304 of FIG. 29.

FIG. 33 is a diagram exemplifying an induction screen displayed on the display in step S306 in FIG. 29.

FIG. 34 is a diagram exemplifying a Wi-Fi connection setting screen displayed on a display of a terminal in step S307 of FIG. 29.

FIG. 35 is a diagram exemplifying a confirmation screen displayed on the display in step S309 of FIG. 29.

FIG. 36 is a diagram exemplifying a notification screen 212 (two-dimensional code issuance screen) displayed on a display 131 in step S311 of FIG. 29.

FIG. 37 is a flowchart for describing an example of processing related to a user interface of an IC card issuing machine 103 in FIG. 28 at the time of issuing the IC card.

FIG. 38 is a diagram exemplifying a selection screen displayed on the display in step S351 of FIG. 37.

FIG. 39 is a diagram exemplifying an induction screen displayed on a display 151 in step S353 of FIG. 37.

FIG. 40 is a diagram exemplifying an induction screen displayed on the display 151 in step S355 of FIG. 37.

FIG. 41 is a diagram exemplifying a notification screen displayed on the display 151 in step S357 of FIG. 37.

FIG. 42 is a block diagram illustrating a configuration example of hardware of a computer that executes a series of processing by a program.

### MODE FOR CARRYING OUT THE INVENTION

Hereinafter, embodiments of the present technology will be described with reference to the drawings.

### First Embodiment of Information Processing System

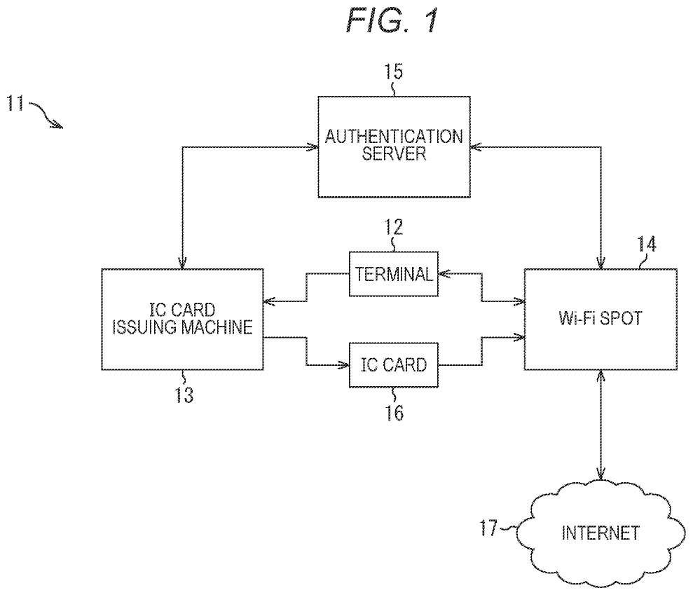

FIG. 1 is a block diagram illustrating a schematic configuration example of a first embodiment of an information processing system to which the present technology is applied.

In FIG. 1, an information processing system 11 includes a terminal 12 as a communication terminal, IC card issuing machines 13 as information processing devices, Wi-Fi spots 14 as external information devices or information terminals, an authentication server 15 as a server device, and an IC card 16 as a medium storing identification information.

The terminal 12 is a communication terminal having a wireless communication function based on Wi-Fi (registered trademark), which is a standard of a wireless local area network (LAN). For example, the terminal 12 is any type of terminal such as a smartphone or a tablet terminal. The terminal 12 in FIG. 1 represents an unspecified terminal possessed by a user of a public wireless LAN (service for providing connection to an Internet 17 using Wi-Fi). Furthermore, users mainly targeted by the information processing system 11 are travelers from overseas, but the users are not limited to travelers from overseas.

The IC card issuing machines 13 are installed in a plurality of places such as airports and stations. Each of the IC card issuing machines 13 issues the IC card 16 for an owner of the terminal 12 to use the public wireless LAN. When issuing the IC card 16, the IC card issuing machine 13 acquires personal information for specifying the user and terminal information for specifying the terminal 12 used by the user.

In addition, the IC card issuing machine 13 associates (associates) the acquired personal information and terminal information of the user with unique identification information (card identification number) stored in the IC card 16 issued to the user, and causes the authentication server 15 to register the associated information as user information.

The Wi-Fi spots 14 are installed in a plurality of places such as sightseeing spots and stations. Each of the Wi-Fi spots 14 has a function of establishing wireless connection based on Wi-Fi (Wi-Fi connection) with the terminal 12, and a function of connecting the terminal 12 with which the Wi-Fi spot 14 establishes the Wi-Fi connection to the Internet 17.

The Wi-Fi spot 14 acquires the card identification number from the IC card 16 of the user who intends to start using the public wireless LAN, and causes the authentication server 15 to collate the acquired card identification number with the user information registered in the authentication server 15. The Wi-Fi spot 14 then acquires the terminal information associated with the card identification number from the authentication server 15, and permits the terminal 12 indicated by the acquired terminal information to connect to the Internet 17 using Wi-Fi.

The authentication server 15 is connected to the IC card issuing machines 13 and the Wi-Fi spots 14 via a communication line. The authentication server 15 stores (registers) the personal information and the terminal information of the user and the card identification number, which are supplied from one of the IC card issuing machines 13 when the IC card 16 is issued, in association with each other as the user information.

Furthermore, when the card identification number of the IC card 16 is supplied from one of the Wi-Fi spots 14, the authentication server 15 collates the card identification number from the Wi-Fi spot 14 with the user information registered in advance. The authentication server 15 then extracts, from the user information, the terminal information associated with the card identification number from the Wi-Fi spot 14, and transmits the extracted terminal information to the Wi-Fi spot 14.

The IC card 16 is, for example, a contactless IC card based on a standard of FeliCa (registered trademark), and is a card in which an IC chip and an antenna are incorporated. However, the IC card 16 may be a contactless IC card based on a standard other than that of FeliCa (registered trademark), or may be a contact IC card. Furthermore, the IC card 16 may have at least one of an electronic money function or a boarding card function for convenience of the user.

According to the information processing system 11 described above, a user such as a traveler from overseas who desires to use a domestic public wireless LAN causes the IC card issuing machine 13 installed at an airport or the like to acquire personal information using a passport, a driver's license, or the like as identification. Furthermore, the user causes the IC card issuing machine 13 to acquire terminal information such as the model and the media access control (MAC) address of the terminal 12 used for the public wireless LAN. As a result, the IC card 16 is issued from the IC card issuing machine 13, and the user acquires the IC card 16. In the authentication server 15, the personal information and the terminal information of the user and the card identification number of the IC card 16 acquired by the user are registered in association with each other as user information.

As described above, the user does not need to perform redundant operations such as input of an ID and a password or make preparations such as pre-registration, and thus can acquire the IC card 16 without effort. Furthermore, since the personal information and the terminal information of the user are associated with each other, it is possible to prevent an unspecified user from using the Wi-Fi spots 14 and to suppress a cyberattack by a malicious user. In addition, even in a case where the IC card 16 is lost, leakage of the personal information is prevented because the personal information and the like are not stored in the IC card 16.

In a case where the user who has acquired the IC card 16 wants to use the public wireless LAN, the user causes one of the Wi-Fi spots 14, which is installed at a sightseeing spot, a station, or the like, to acquire the card identification number of the IC card 16. The Wi-Fi spot 14 acquires the terminal information associated in advance with the card identification number of the IC card 16 from the authentication server 15, and permits the terminal 12 indicated by the terminal information to connect to the Internet 17 using Wi-Fi.

The user selects Wi-Fi connection with the network name (SSID) of the Wi-Fi spot 14 in a Wi-Fi connection setting of network settings of the terminal 12, whereby the terminal 12 establishes the Wi-Fi connection with the Wi-Fi spot 14, and is connected to the Internet 17 via the Wi-Fi spot 14.

As described above, for permitting the user to use the public wireless LAN, it is only required to cause the Wi-Fi spot 14 to acquire the card identification number of the IC card 16, and thus an effort of and a burden on the user are small.

<Flow Up to Issuance of IC Card>

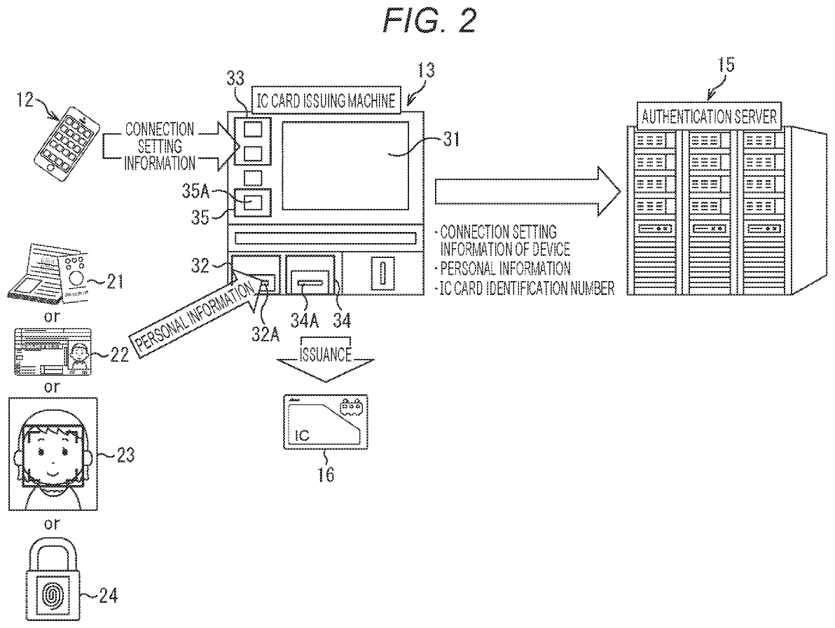

FIG. 2 is a diagram for describing an appearance of the IC card issuing machine 13 and a flow up to issuance of the IC card 16. Note that, in the drawing, portions corresponding to those of the information processing system 11 in FIG. 1 are denoted by the same reference signs, and description thereof will be omitted as appropriate.

In FIG. 2, the IC card issuing machine 13 includes a display 31, a personal information acquisition unit 32, a terminal information acquisition unit 33, an IC card issuing unit 34, and an IC card information acquisition unit 35.

The display 31 displays a guidance screen or the like for guiding a user who applies for use of a public wireless LAN to an operation of an application procedure. In addition, the display 31 includes a touch panel on a screen surface, and the touch panel detects a touch operation of the user on the screen.

The personal information acquisition unit 32 includes a passport insertion port 32A into which the user inserts a passport 21 necessary for the application. The personal information acquisition unit 32 acquires, as personal information, information regarding identification matters of the passport 21 inserted from the passport insertion port 32A. The information regarding the identification matters of the passport 21 includes the passport number (passport number), the name, the nationality, the date of birth, the sex, the face photograph, or the like, and the personal information acquisition unit 32 may acquire all or only a part of the information regarding the identification matters of the passport 21.

The IC card issuing machine 13 transmits the personal information acquired by the personal information acquisition unit 32 to the authentication server 15 connected via a communication line. The authentication server 15 examines whether or not the user who applies for issuance of the IC card 16 is registered in a blacklist on the basis of the personal information from the IC card issuing machine 13, and transmits the examination result to the IC card issuing machine 13. The blacklist is a list of persons who are prohibited from issuing the IC card 16 (using the public wireless LAN).

Note that the personal information acquisition unit 32 may read a character image of a necessary part and the face photograph in the passport 21 by a scanner and convert the character image into character information (character code) by character recognition processing, or may acquire, in the case of an IC passport with an IC chip incorporated therein, the information regarding the identification matters from the IC chip by a reader.

Furthermore, the personal information acquisition unit 32 may acquire the personal information (driver's license number, name, nationality, date of birth, sex, face photograph, or the like) from an identification document with which the user can be identified in his or her home country, such as a driver's license 22, instead of the passport 21. Moreover, instead of acquiring the personal information from the identification document or in addition to acquiring the personal information from the identification document, the personal information acquisition unit 32 may acquire a face photograph 23 of the user by an imaging unit or may acquire a fingerprint image 24 of the user by a fingerprint sensor. In addition, at least one of the passport number or the driver's license number may be necessarily acquired as the personal information.

However, a case will be described below where the personal information acquisition unit 32 acquires the personal information mainly from the passport 21.

The terminal information acquisition unit 33 acquires terminal information for specifying the terminal 12. The acquired terminal information is, for example, the model name and the MAC address of the terminal 12.

The terminal information acquisition unit 33 includes, for example, a wireless communication unit (not illustrated) that operates as a wireless LAN access point and performs wireless communication based on Wi-Fi connection. The user causes his or her own terminal 12 to establish Wi-Fi connection with the wireless communication unit of the terminal information acquisition unit 33 by using the SSID and the authentication key (password) displayed on the display 31. The terminal information acquisition unit 33 acquires the model name, the MAC address, and the like of the terminal 12 by the Wi-Fi connection with the terminal 12.

Note that the terminal information acquisition unit 33 may include a short-range wireless communication unit that performs short-range wireless communication based on a standard of near field communication (NFC). In a case where the terminal 12 has an NFC function, the terminal 12 is brought close to an NFC reception unit of the short-range wireless communication unit of the terminal information acquisition unit 33 to perform short-range wireless communication, whereby the terminal information acquisition unit 33 acquires the terminal information of the terminal 12. The terminal 12 having the NFC function can reduce the effort of the user to establish Wi-Fi connection. Even if the terminal 12 does not have the NFC function, it is possible to acquire the terminal information by Wi-Fi connection, and thus many users can acquire the IC card 16.

The IC card issuing unit 34 includes an IC card sending port 34A. In a case where the user is not registered in the blacklist according to the examination result from the authentication server 15, the IC card issuing unit 34 takes out one unused IC card 16 from a storage portion (not illustrated) and sends out the IC card 16 from the IC card sending port 34A. Note that the IC card issuing unit 34 does not issue the IC card 16 in a case where the user is registered in the blacklist. However, the IC card 16 may be issued even to a user registered in the blacklist. When the user registered in the blacklist connects to the Internet using the Wi-Fi spot 14, access control according to an attribute of the user may be performed.

When the IC card issuing unit 34 issues the IC card 16, the card identification number recorded in advance in the IC card 16 is acquired by an IC card reader (not illustrated).

When the IC card issuing machine 13 issues the IC card 16, the IC card issuing machine 13 transmits the personal information of the user, which has been acquired from the passport 21 of the user, the terminal information of the terminal 12, and the card identification number of the issued IC card 16 to the authentication server 15.

However, identification information different from the card identification number of the IC card 16 may be generated and stored in the IC card 16.

In a case where a plurality of users uses the public wireless LAN with one IC card 16, the IC card information acquisition unit 35 acquires the card identification number of an already issued IC card 16. The IC card information acquisition unit 35 includes a touch frame portion 35A over which the user holds the IC card 16, and a short-range wireless communication unit (not illustrated) that performs short-range wireless communication based on NFC with the IC card 16. When the user holds the already issued IC card 16 over the touch frame portion 35A, the IC card information acquisition unit 35 acquires the card identification number of the IC card 16 by the short-range wireless communication between the IC card 16 and the short-range wireless communication unit. After acquiring the card identification number of the already issued IC card 16, the IC card information acquisition unit 35 acquires personal information and terminal information of a user to be newly added by the personal information acquisition unit 32 and the terminal information acquisition unit 33, transmits the acquired personal information, terminal information, and card identification number to the authentication server 15, and registers the transmitted personal information, terminal information, and card identification number as user information, similarly to the case of newly issuing the IC card 16.

Along with the issuance of the IC card 16, the authentication server 15 registers the personal information, the terminal information, and the card identification number transmitted from the IC card issuing machine 13 in association with each other as the user information.

<Processing at the Time of Issuing IC Card>

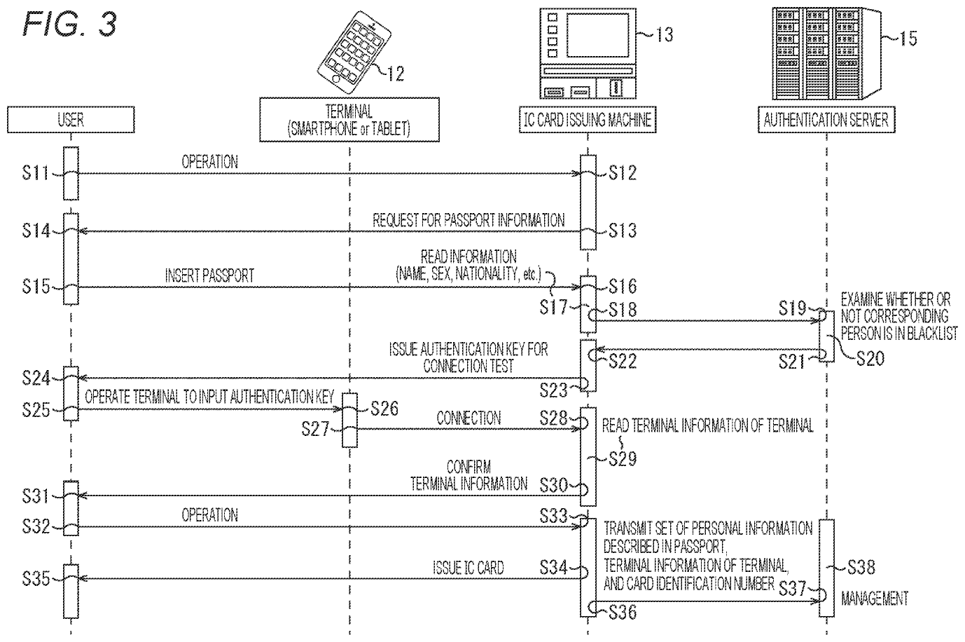

FIG. 3 is a sequence diagram for describing processing of the user, the terminal 12, the IC card issuing machine 13, and the authentication server 15 at the time of issuing the IC card.

In step S11, the user performs an operation of starting the application procedure for use of the public wireless LAN on the IC card issuing machine 13.

In step S12, the IC card issuing machine 13 detects the operation of the user in step S11.

In step S13, the IC card issuing machine 13 requests passport information from the user.

In step S14, the user receives the request for the passport information.

In step S15, the user inserts the passport 21 from the passport insertion port 32A of the personal information acquisition unit 32 of the IC card issuing machine 13.

In step S16, the IC card issuing machine 13 receives the passport 21 by the personal information acquisition unit 32.

In step S17, the IC card issuing machine 13 acquires the information regarding the identification matters of the passport 21 as the personal information by the personal information acquisition unit 32.

In step S18, the IC card issuing machine 13 transmits the personal information acquired in step S17 to the authentication server 15.

In step S19, the authentication server 15 receives the personal information from the IC card issuing machine 13.

In step S20, the authentication server 15 examines whether or not the user is a person registered in the blacklist on the basis of the personal information.

In step S21, the authentication server 15 transmits the examination result in step S20 to the IC card issuing machine 13.

In step S22, the IC card issuing machine 13 receives the examination result from the authentication server 15. Note that, in step S22, it is assumed that the IC card issuing machine 13 has received the examination result indicating that the user is not a person registered in the blacklist. In a case where the user is a person registered in the blacklist, the IC card 16 is not issued.

In step S23, the IC card issuing machine 13 issues the authentication key for a connection test, and displays the SSID and the authentication key for Wi-Fi connection on the display 31.

In step S24, the user recognizes the SSID and the authentication key for Wi-Fi connection displayed on the display 31.

In step S25, the user operates the terminal 12 to select the SSID recognized in step S24 in the Wi-Fi connection setting of the network settings, and to input the authentication key recognized in step S24.

In step S26, in response to the operation performed in step S25, the terminal 12 acquires the SSID selected in step S25 and the authentication key input in step S25.

In step S27, the terminal 12 requests Wi-Fi connection to the network (access point) indicated by the SSID acquired in step S26 using the authentication key acquired in step S26.

In step S28, the IC card issuing machine 13 receives the connection request from the terminal 12 in step S27, and establishes Wi-Fi connection with the terminal 12.

In step S29, the IC card issuing machine 13 acquires the terminal information of the terminal 12.

In step S30, the IC card issuing machine 13 displays the terminal information of the terminal 12 acquired in step S29 on the display 31, and requests the user to confirm that the terminal information of the terminal 12 of the user is being displayed.

In step S31, the user recognizes the confirmation request displayed on the display 31 in step S30.

In step S32, the user operates the IC card issuing machine 13 to input confirmation that the terminal information of the terminal 12 of the user is being displayed.

In step S33, the IC card issuing machine 13 accepts the operation of the user in step S32.

In step S34, the IC card issuing machine 13 sends out the IC card 16 from the IC card sending port 34A of the IC card issuing unit 34, and issues the IC card 16.

In step S35, the user receives the IC card 16 issued in step S34.

In step S36, the IC card issuing machine 13 transmits the personal information acquired in step S17, the terminal information of the terminal 12 acquired in step S29, and the card identification number of the IC card 16 issued in step S34 to the authentication server 15.

In step S37, the authentication server 15 receives the personal information, the terminal information, and the card identification number from the IC card issuing machine 13.

In step S38, the authentication server 15 registers (manages) the personal information, the terminal information, and the card identification number received in step S37 in association with each other as the user information.

As described above, the user can acquire the IC card 16, and the personal information of the user, the terminal information of the terminal 12 used by the user, and the card identification number of the IC card 16 issued to the user are registered in the authentication server 15 in association with each other. The user can register the personal information only by using the passport 21, can register the terminal information of the terminal 12 only by wirelessly connecting the terminal 12 to the IC card issuing machine 13, and thus can perform the procedure for issuing the IC card 16 easily and quickly. Furthermore, even in a case where the user loses the IC card 16, leakage of the personal information is prevented because the personal information and the like are not stored in the IC card 16.

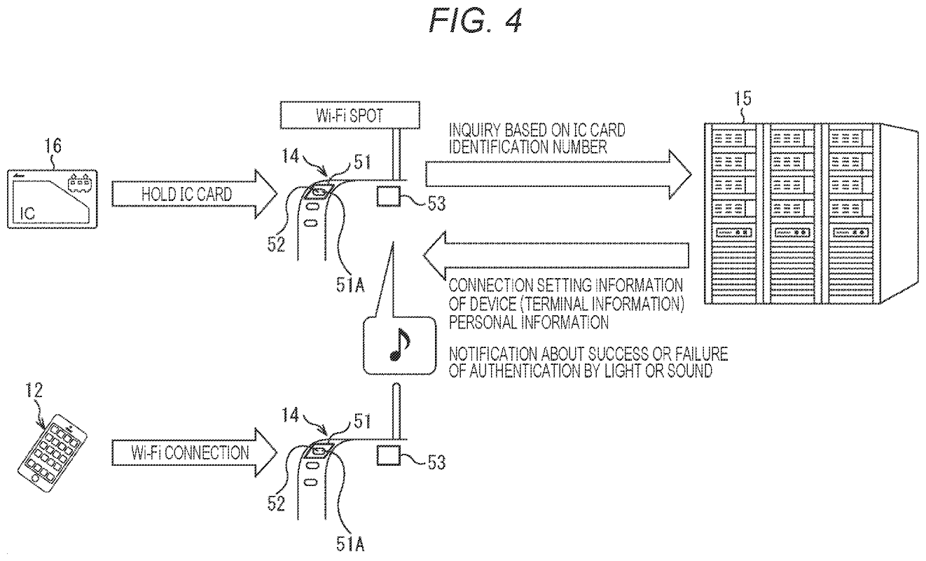

FIG. 4 is a diagram for describing an appearance of the Wi-Fi spot 14 and a flow from issuance of the IC card to start of use of the public wireless LAN. Note that, in the drawing, portions corresponding to those of the information processing system 11 in FIG. 1 are denoted by the same reference signs, and description thereof will be omitted as appropriate.

In FIG. 4, the Wi-Fi spot 14 includes an IC card information acquisition unit 51, an authentication result notification unit 52, and a wireless communication unit 53.

The IC card information acquisition unit 51 includes a touch frame portion 51A over which the IC card 16 is held. The user holds the IC card 16 acquired by the IC card issuing machine 13 over the touch frame portion 51A (brings the IC card 16 close to the touch frame portion 51A). The IC card information acquisition unit 51 performs short-range communication based on NFC with the IC card 16 brought close to the touch frame portion 51A, and acquires the card identification number of the IC card 16.

The Wi-Fi spot 14 transmits the card identification number acquired by the IC card information acquisition unit 51 to the authentication server 15. The authentication server 15 examines whether or not the card identification number from the Wi-Fi spot 14 is registered as the user information. In a case where the card identification number from the Wi-Fi spot 14 is registered as the user information, the authentication server 15 transmits, to the Wi-Fi spot 14, a notification that the authentication has succeeded together with the personal information and the terminal information associated with the card identification number from the Wi-Fi spot 14. In a case where the card identification number from the Wi-Fi spot 14 is not registered as the user information, the authentication server 15 transmits a notification that the authentication has failed to the Wi-Fi spot 14.

The authentication result notification unit 52 includes an indicator and notifies the user of the authentication result (success or failure) from the authentication server 15 by lighting the indicator or the like. The authentication result notification unit 52 may notify the user of the authentication result by sound.

The wireless communication unit 53 performs wireless communication based on Wi-Fi connection with the terminal 12. The wireless communication unit 53 permits the Wi-Fi connection with the terminal 12 indicated by the terminal information given from the authentication server 15 together with the notification of the authentication success from the authentication server 15. When the user operates the terminal 12 to select the SSID of the Wi-Fi spot 14 in the Wi-Fi connection setting of the network settings, the Wi-Fi connection between the terminal 12 and the wireless communication unit 53 is established, and the terminal 12 is connected to the Internet via the Wi-Fi connection.

Furthermore, when the Wi-Fi connection between the terminal 12 and the wireless communication unit 53 is established, the Wi-Fi spot 14 transmits various types of guidance information for the terminal 12 by communication based on the Wi-Fi connection, and causes the terminal 12 to display a guidance screen.

<Processing at Start of Use of Public Wireless LAN>

FIG. 5 is a sequence diagram for describing processing of the user, the terminal 12, the Wi-Fi spot 14, and the authentication server 15 at the start of use of the public wireless LAN.

In step S51, the user holds the IC card 16 over the touch frame portion 51A (see FIG. 4) of the Wi-Fi spot 14.

In step S52, in the Wi-Fi spot 14, the IC card 16 is brought close to the touch frame portion 51A of the IC card information acquisition unit 51.

In step S53, the IC card information acquisition unit 51 of the Wi-Fi spot 14 performs short-range communication based on NFC with the IC card 16 to acquire the card identification number of the IC card 16.

In step S54, the Wi-Fi spot 14 transmits the card identification number acquired in step S52 to the authentication server 15, and inquires whether the card identification number is registered as the user information.

In step S55, the authentication server 15 receives the card identification number from the Wi-Fi spot 14.

In step S56, the authentication server 15 performs authentication processing as to whether or not the card identification number from the Wi-Fi spot 14 is present in the user information. That is, the authentication server 15 searches the user information for the card identification number from the Wi-Fi spot 14. Then, in a case where the card identification number from the Wi-Fi spot 14 is present in the user information, the authentication server 15 determines that the authentication has succeeded. Furthermore, in a case where the card identification number from the Wi-Fi spot 14 is not present in the user information, the authentication server 15 determines that the authentication has failed. Here, it is assumed that the authentication has succeeded.

In step S57, the authentication server 15 extracts, from the user information, the personal information and the terminal information associated with the card identification number from the Wi-Fi spot 14, and transmits the extracted personal information and terminal information to the Wi-Fi spot 14 together with the notification that the authentication has succeeded.

In step S58, the Wi-Fi spot 14 receives the notification that the authentication has succeeded together with the personal information and the terminal information transmitted from the authentication server 15.

In step S59, the Wi-Fi spot 14 turns on (lights) the indicator of the authentication result notification unit 52.

In step S60, the user recognizes that the indicator of the authentication result notification unit 52 of the Wi-Fi spot 14 has been turned on, and recognizes that the authentication has succeeded.

In step S61, the user operates the terminal 12 to select the SSID of the Wi-Fi spot 14 in the Wi-Fi connection setting of the network settings. Note that the SSID of the Wi-Fi spot 14 is indicated, for example, near the touch frame portion 51A over which the IC card 16 is held.

In step S62, the terminal 12 sets Wi-Fi connection to the SSID of the Wi-Fi spot 14.

In step S63, the terminal 12 transmits a request for the Wi-Fi connection to the Wi-Fi spot 14.

In step S64, the wireless communication unit 53 of the Wi-Fi spot 14 receives the request for the Wi-Fi connection from the terminal 12, and acquires the terminal information of the terminal 12.

In step S65, the Wi-Fi spot 14 collates the terminal information of the terminal 12 acquired in step S64 with the terminal information acquired from the authentication server 15 in step S57. Here, it is assumed that the former and the latter match.

In step S66, the wireless communication unit 53 of the Wi-Fi spot 14 accepts the request for the Wi-Fi connection with the terminal 12, establishes the Wi-Fi connection with the terminal 12, and enables connection to the Internet.

In step S67, the terminal 12 establishes the Wi-Fi connection with the wireless communication unit 53 of the Wi-Fi spot 14, and is connected to the Internet.

In step S68, the Wi-Fi spot 14 transmits, to the authentication server 15, a notification that the terminal 12 has established the Wi-Fi connection (notification of addition of a use terminal).

In step S69, the authentication server 15 receives the notification of addition of a use terminal from the Wi-Fi spot 14. The authentication server 15 obtains the cumulative number of terminals with which each of the Wi-Fi spots 14 installed in the plurality of places establishes Wi-Fi connection, and records the cumulative number as use history information of each of the Wi-Fi spots 14. The authentication server 15 receives the notification of addition of a use terminal from each of the Wi-Fi spots 14, thereby updating the use history information of each of the Wi-Fi spots 14. The use history information can be utilized as big data.

As described above, the user can easily and securely start using the public wireless LAN. Furthermore, since a user who has not acquired the IC card 16 cannot establish Wi-Fi connection with the Wi-Fi spots 14, it is possible to prevent an unspecified user from using the public wireless LAN and a cyberattack by a malicious user is suppressed.

Note that the authentication server 15 may update the use history information when receiving the card identification number from each of the Wi-Fi spots 14. In addition, the authentication server 15 may record, as the use history information, position information of the Wi-Fi spot 14, information regarding a use situation of the Wi-Fi spot 14, and the personal information.

Furthermore, when the terminal 12 establishes Wi-Fi connection one of the Wi-Fi spots 14, the Wi-Fi spot 14 may transmit, to the terminal 12, guidance information indicating installation places of nearby Wi-Fi spots, nearby tourist spots, or the like, and cause the display of the terminal 12 to display the guidance information.

<Exemplification of Information Screen when Wi-Fi Connection is Established>

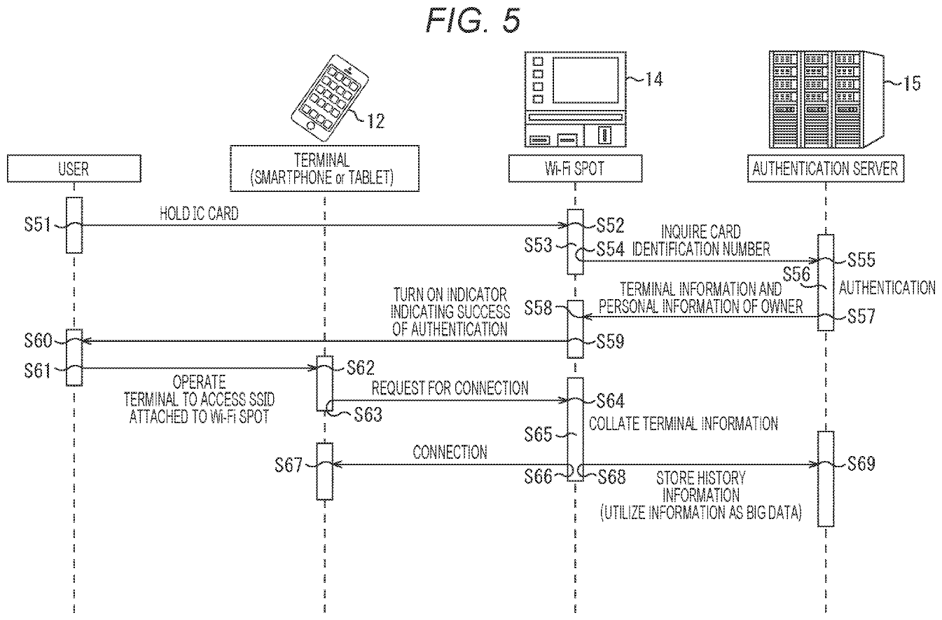

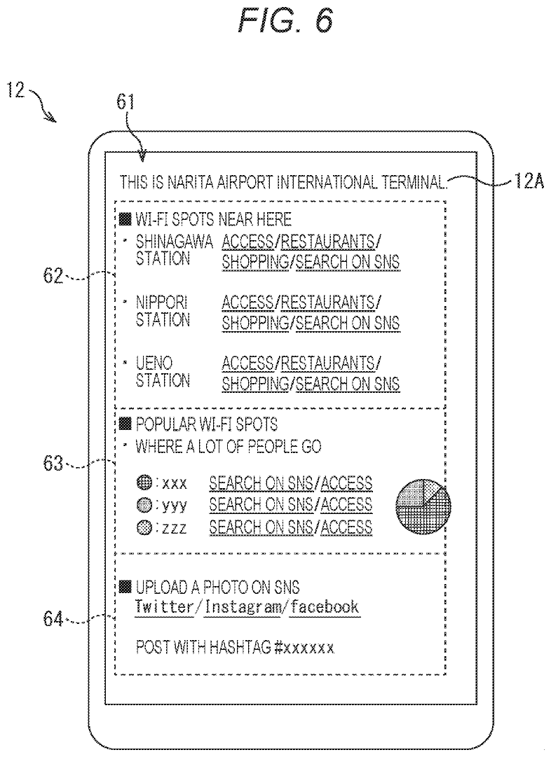

FIG. 6 is a diagram exemplifying an information screen displayed on the display of the terminal 12 when the Wi-Fi connection between the terminal 12 and the Wi-Fi spot 14 is established.

In FIG. 6, an information screen 61 displayed on a display 12A of the terminal 12 is generated by the Wi-Fi spot 14, for example, as a web page in a language corresponding to the nationality of the user, and is transmitted to the terminal 12. In the terminal 12, a web browser is activated, and the information screen 61 is displayed on the display 12A. Note that the Wi-Fi spot 14 acquires the personal information associated with the card identification number of the IC card 16 from the authentication server 15, and detects the nationality of the user.

On the information screen 61 in FIG. 6, the place of the Wi-Fi spot 14 with which the terminal 12 is currently establishing the Wi-Fi connection is displayed at the top. A first information unit 62 below the top is an area for displaying information regarding Wi-Fi spots installed nearby. A second information unit 63 is an area for displaying information regarding popular Wi-Fi spots. A third information unit 64 is an area for displaying information regarding information sharing on SNSs.

The first information unit 62 displays the installation places of the nearby Wi-Fi spots (access points), links to pages displaying how to get to the installation places, links to pages displaying information regarding restaurants and shopping around the installation places, and links to pages for searching the SNSs. For example, on the pages accessed from the links indicated in the first information unit 62, information regarding the nearby Wi-Fi spots, such as a map of a station, which is difficult to find on a general map, a train timetable, and a station home number, is displayed as an image or the like.

The second information unit 63 displays links to pages displaying installation places of the popular Wi-Fi spots and how to get to the Wi-Fi spots. When the popular Wi-Fi spots are determined, the use history information recorded in the authentication server 15 is referred to.

The third information unit 64 displays links to the SNSs and a hash tag used in uploading a photograph on the SNSs.

<Configuration Example of IC Card Issuing Machine>

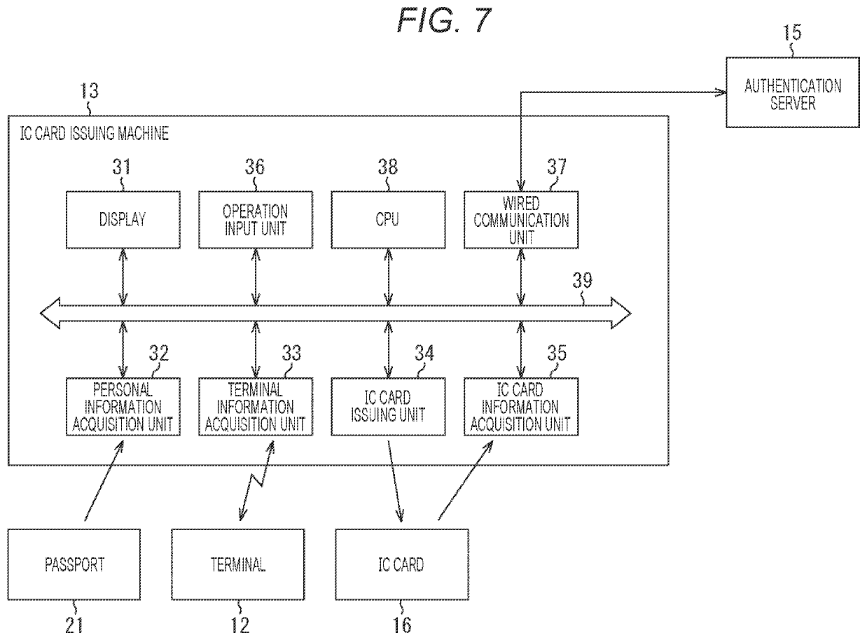

FIG. 7 is a block diagram for describing a configuration example of the IC card issuing machine 13.

In FIG. 7, the IC card issuing machine 13 includes the display 31, the personal information acquisition unit 32, the terminal information acquisition unit 33, the IC card issuing unit 34, the IC card information acquisition unit 35, an operation input unit 36, a wired communication unit 37, a central processing unit (CPU) 38, and a bus 39.

The display 31 displays the guidance screen or the like for guiding the user who applies for use of the public wireless LAN to the operation of the application procedure.

The personal information acquisition unit 32 acquires, as the personal information, the passport number (passport number), the name, the nationality, the date of birth, the sex, the face photograph, or the like, which is the information regarding the identification matters recorded in the passport 21 of the user.

The terminal information acquisition unit 33 acquires the terminal information of the terminal 12 used when the user uses the public wireless LAN. The terminal information acquisition unit 33 includes the wireless communication unit (not illustrated) that operates as a wireless LAN access point, and acquires, from the terminal 12, the model name and the MAC address of the terminal 12, for example, as the terminal information by the wireless communication unit establishing Wi-Fi connection with the terminal 12.

The IC card issuing unit 34 takes out one IC card 16 from the storage portion (not illustrated) in which a large number of unused IC cards 16 are stored, and sends out the IC card 16 from the IC card sending port 34A (see FIG. 2).

In a case where, for example, a plurality of users uses the public wireless LAN with one IC card 16, the IC card information acquisition unit 35 acquires the card identification number of an already issued IC card 16. The IC card information acquisition unit 35 includes the touch frame portion 35A (see FIG. 2) over which the user holds the IC card 16, and the short-range wireless communication unit (not illustrated) that performs short-range wireless communication based on NFC with the IC card 16. When the user holds the already issued IC card 16 over the touch frame portion 35A, the IC card information acquisition unit 35 acquires the card identification number of the IC card 16 by the short-range wireless communication between the IC card 16 and the short-range wireless communication unit.

The operation input unit 36 detects a user operation on the touch panel provided on the display 31 or an operation button.

The wired communication unit 37 performs wired communication with the authentication server 15 through a dedicated line or the like. Note that the IC card issuing machine 13 and the authentication server 15 may be connected via the Internet.

The CPU 38 executes a program recorded in a read only memory (ROM) (not illustrated), a magnetic disk, or a non-volatile storage unit (not illustrated), thereby executing overall processing in the IC card issuing machine 13. Furthermore, the CPU 38 gives a command to each of the display 31, the personal information acquisition unit 32, the terminal information acquisition unit 33, the IC card issuing unit 34, the operation input unit 36, and the wired communication unit 37 via the bus 39 to control the operation of each unit, and exchanges various types of data via the bus 39.

The bus 39 connects the display 31, the personal information acquisition unit 32, the terminal information acquisition unit 33, the IC card issuing unit 34, the IC card information acquisition unit 35, the operation input unit 36, the wired communication unit 37, and the CPU 38 to each other, and transmits various types of data.

<Processing Related to User Interface at the Time of Issuing IC Card>

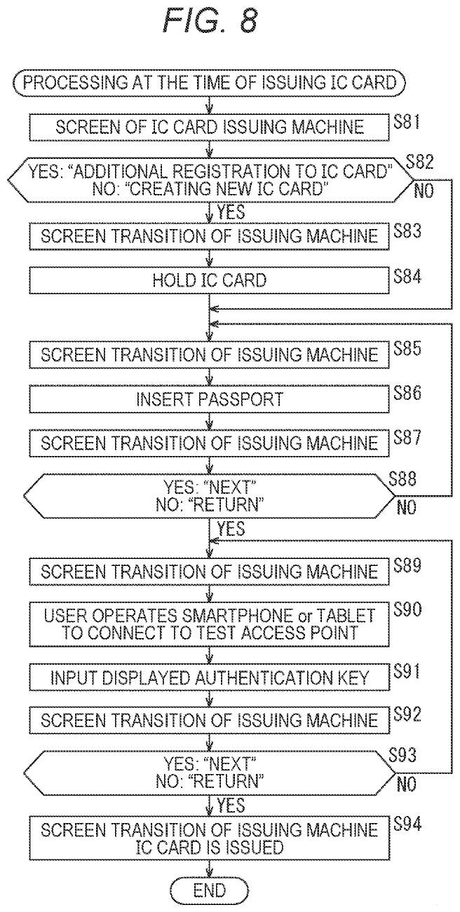

FIG. 8 is a flowchart for describing an example of processing related to a user interface of the IC card issuing machine 13 in FIG. 7 at the time of issuing the IC card.

In step S81, the CPU 38 causes the display 31 to display a selection screen on which the user selects either creating a new IC card or registering an additional user to his or her IC card (card identification number) (additional registration to the IC card). The processing proceeds from step S81 to step S82. Note that display of an initial screen for selecting a language and an operation on the initial screen are omitted, and the display 31 displays information in the language selected by the user. In the description of this flowchart, it is assumed that Japanese is selected.

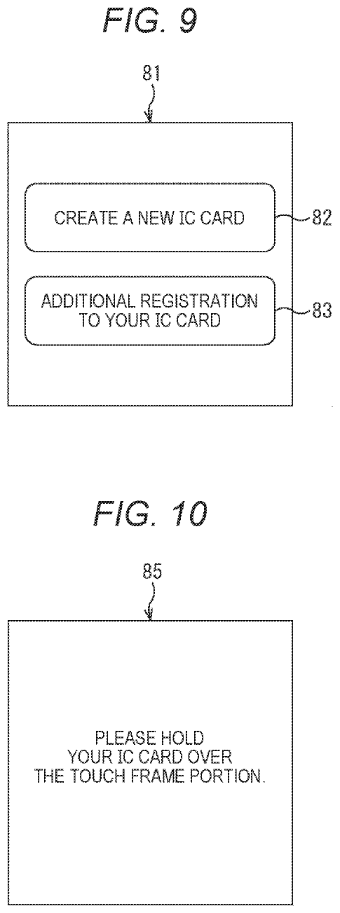

FIG. 9 is a diagram exemplifying the selection screen displayed on the display 31 in step S81. In FIG. 9, a selection screen 81 displays a first button image 82 and a second button image 83. On the first button image 82, character information “create a new IC card”, which is a first option, is displayed in a superimposed manner. On the second button image 83, display information “additional registration to your IC card”, which is a second option, is displayed in a superimposed manner. The user touches the display position of the first button image 82 or the second button image 83 on the selection screen 81 to select either the first option or the second option.

Here, the second option is selected in a case where a plurality of users uses the public wireless LAN with one IC card 16 or in a case where one user uses a plurality of terminals 12. In a case where a family is traveling or a plurality of people is traveling together, the plurality of people or the plurality of terminals 12 can use the public wireless LAN with one IC card 16, and thus it is possible to reduce the time and effort for the procedure for starting using the public wireless LAN. In addition, the second option is selected also in a case where the user possesses the same type of IC card used in a system other than the information processing system to which the present technology is applied, and wants to use the IC card in the information processing system to which the present technology is applied.

In step S82, the CPU 38 determines which one of the first option and the second option has been selected on the basis of the user operation (touch position) obtained by the operation input unit 36.

In step S82, in a case where the user selects the first option, the processing skips steps S83 and S84 and proceeds to step S85.

On the other hand, in step S82, in a case where the user selects the second option, the processing proceeds to step S83, and the CPU 38 causes the display 31 to display an induction screen for inducing the user to hold the already issued IC card 16 over the touch frame portion 35A (see FIG. 2) of the IC card information acquisition unit 35. The processing proceeds from step S83 to step S84.

FIG. 10 is a diagram exemplifying the induction screen displayed on the display 31 in step S83. In FIG. 10, an induction screen 85 displays character information “please hold your IC card over the touch frame portion”.

In step S84, the user holds the IC card 16 over the touch frame portion 35A. The CPU 38 acquires the card identification number of the IC card 16 by the IC card information acquisition unit 35. The processing proceeds from step S84 to step S85.

In step S85, the CPU 38 causes the display 31 to display an induction screen for inducing the user to insert the passport 21 into the passport insertion port 32A (see FIG. 2) of the personal information acquisition unit 32. The processing proceeds from step S85 to step S86.

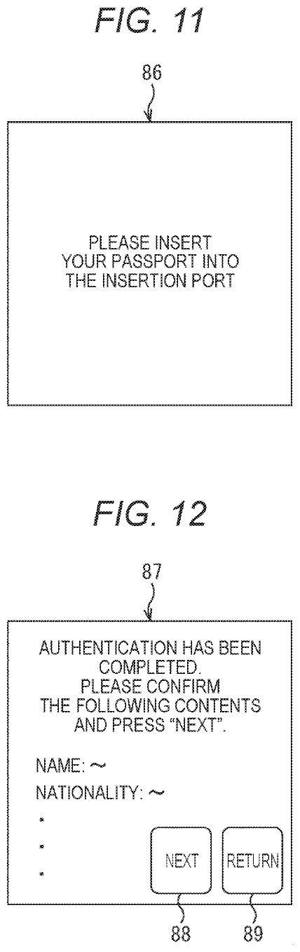

FIG. 11 is a diagram exemplifying the induction screen displayed on the display 31 in step S85. In FIG. 11, an induction screen 86 displays character information “please insert your passport into the insertion port”.

In step S86, the user inserts the passport 21 into the passport insertion port 32A of the personal information acquisition unit 32. The CPU 38 acquires, by the personal information acquisition unit 32, information such as the passport number, the name, the nationality, the date of birth, the sex, the face photograph, or the like, which is the information regarding the identification matters of the passport 21. The processing proceeds from step S86 to step S87.

In step S87, the CPU 38 causes the display 31 to display a confirmation screen for the user to confirm the personal information acquired from the passport 21. The processing proceeds from step S87 to step S88.

FIG. 12 is a diagram exemplifying the confirmation screen displayed on the display 31 in step S87. In FIG. 12, a confirmation screen 87 displays the contents of the personal information acquired in step S86. Furthermore, the confirmation screen 87 displays a first button image 88 and a second button image 89. On the first button image 88, character information “next” is displayed in a superimposed manner, and the user touches the position of the first button image 88 in a case where the personal information displayed on the confirmation screen 87 is correct. On the second button image 89, character information “return” is displayed in a superimposed manner, and the user touches the position of the second button image 89 in a case where the personal information displayed on the confirmation screen 87 is incorrect.

In step S88, the CPU 38 determines whether or not the personal information displayed on the confirmation screen 87 in FIG. 12 is correct on the basis of the user operation (touch position) obtained by the operation input unit 36.

In a case where it is determined in step S88 that the personal information displayed on the confirmation screen 87 is incorrect (in a case where the position of the second button image 89 is touched), the processing returns from step S88 to step S85 and repeats steps S85 to S88.

On the other hand, in a case where it is determined in step S88 that the personal information displayed on the confirmation screen 87 is correct (in a case where the position of the first button image 88 is touched), the processing proceeds to step S89, and the CPU 38 causes the display 31 to display an induction screen for inducing the user to cause the terminal 12 to establish Wi-Fi connection with the terminal information acquisition unit 33 operating as a test access point of the IC card issuing machine 13. The processing proceeds from step S89 to step S90.

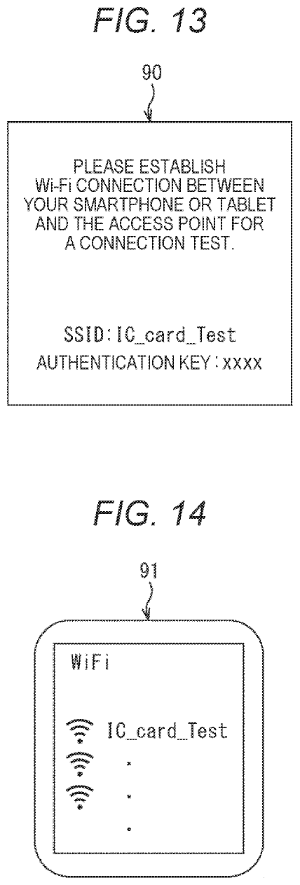

FIG. 13 is a diagram exemplifying the induction screen displayed on the display 31 in step S89. In FIG. 13, an induction screen 90 displays character information “please establish Wi-Fi connection between your smartphone or tablet and the access point for a connection test”, which induces the user to cause the terminal 12 to establish the Wi-Fi connection with the terminal information acquisition unit 33 of the IC card issuing machine 13. In addition, the induction screen 90 displays, for example, character information “SSID: IC card Test”, which indicates the network name (SSID) of the terminal information acquisition unit 33 (the IC card issuing machine 13) as a connection destination to which the terminal 12 of the user establishes the Wi-Fi connection, and character information “authentication key: xxxx”, which indicates the authentication key.

In step S90, the user operates the terminal 12 to select the SSID (IC card Test) displayed on the induction screen 90 in FIG. 13 as the connection destination in the Wi-Fi connection setting of the network settings. The terminal information acquisition unit 33 of the IC card issuing machine 13 receives the request for the Wi-Fi connection from the terminal 12. The processing proceeds from step S90 to step S91.

FIG. 14 is a diagram exemplifying a Wi-Fi connection setting screen displayed on the display of the terminal 12 in step S90. In FIG. 14, the Wi-Fi connection setting screen displays a list of network names (SSIDs) of beacons received by the terminal 12. The user selects the SSID (IC card Test) of the terminal information acquisition unit 33 displayed on the induction screen 90 in FIG. 13 from the list.

In step S91, the user inputs the authentication key (xxxx) displayed on the induction screen 90 in FIG. 13 on a screen for inputting the authentication key, which is displayed on the display of the terminal 12 following the list. As a result, the terminal 12 of the user establishes the Wi-Fi connection with the terminal information acquisition unit 33 of the IC card issuing machine 13. The terminal information acquisition unit 33 then acquires the model name and the MAC address of the terminal 12 as the terminal information by wireless communication based on the Wi-Fi connection with the terminal 12, and supplies the terminal information to the CPU 38. The processing proceeds from step S91 to step S92.

In step S92, the CPU 38 causes the display 31 to display a confirmation screen for the user to confirm the terminal information acquired in step S91. The processing proceeds from step S92 to step S93.

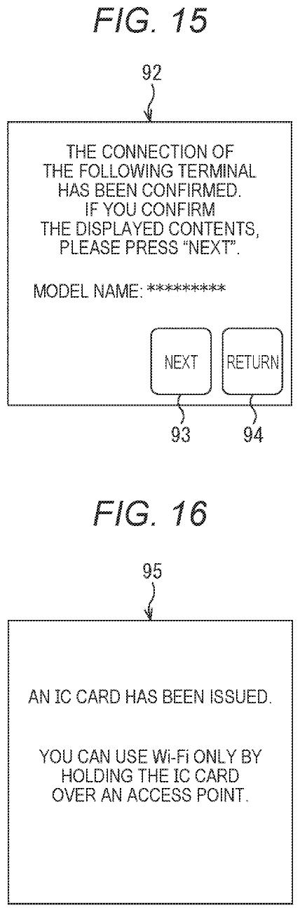

FIG. 15 is a diagram exemplifying the confirmation screen displayed on the display 31 in step S92. In FIG. 15, a confirmation screen 92 displays the model name in the terminal information acquired in step S91. Furthermore, the confirmation screen 92 displays a first button image 93 and a second button image 94. On the first button image 93, character information “next” is displayed in a superimposed manner, and the user touches the position of the first button image 93 in a case where the model name displayed on the confirmation screen 92 is correct. On the second button image 94, character information “return” is displayed in a superimposed manner, and the user touches the position of the second button image 94 in a case where the model name displayed on the confirmation screen 92 is incorrect.

In step S93, the CPU 38 determines whether or not the model name displayed on the confirmation screen 92 in FIG. 15 is correct on the basis of the user operation (touch position) obtained by the operation input unit 36.

In a case where it is determined in step S93 that the model name displayed on the confirmation screen 92 is incorrect (in a case where the position of the second button image 94 is touched), the processing returns from step S93 to step S89 and repeats steps S89 to S93.

On the other hand, in a case where it is determined in step S93 that the model name displayed on the confirmation screen 92 is correct (in a case where the position of the first button image 93 is touched), the processing proceeds to step S94, and the CPU 38 causes the display 31 to display a notification screen indicating that the IC card 16 has been issued. In addition, the CPU 38 causes the IC card issuing unit 34 to send out the IC card 16 from the IC card sending port 34A.

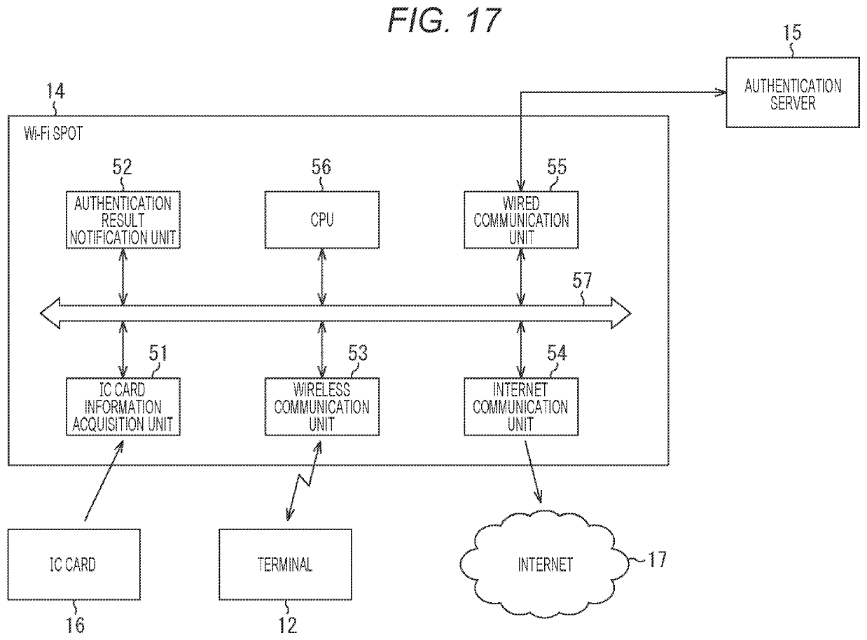

FIG. 16 is a diagram exemplifying the notification screen displayed on the display 31 in step S94. In FIG. 16, a notification screen 95 displays character information “an IC card has been issued” and character information “you can use Wi-Fi only by holding the IC card over an access point”.

Note that, in a case where it is determined in step S82 that the second option has been selected, the new IC card 16 is not issued, and the card identification number of the IC card 16 acquired by the IC card information acquisition unit 35 in step S84 is registered in the authentication server 15 in association with the personal information and the terminal information of the user. In addition, the issuance of the IC card 16 may be limited by an elapsed time from the acquisition of the personal information in step S86. That is, a configuration may be adopted in which the IC card 16 is not issued in a case where the elapsed time from the acquisition of the personal information in step S86 exceeds a predetermined limit time. In addition, a configuration may be adopted in which, in a case where it is determined in step S82 that the second option has been selected (in a case where additional registration to the IC card is selected), the additional registration cannot be performed in a case where an elapsed time from when the personal information of the user was associated with the IC card 16 for the first time exceeds a predetermined limit time. This is to prevent another person from misusing the IC card 16 when the user loses the IC card 16.

Thus, the processing at the time of issuing the IC card ends. As described above, the user can acquire the IC card 16 with a simple operation. In addition, the personal information of the user, the terminal information of the terminal 12 used by the user, and the card identification information of the IC card 16 (or the handheld IC card 16) issued to the user are registered in the authentication server 15 in association with each other. The user can register the personal information only by using the passport 21, and can register the terminal information of the terminal 12 only by wirelessly connecting the terminal 12 to the IC card issuing machine 13. In addition, even in a case where the IC card 16 is lost, leakage of the personal information is prevented because the personal information and the like are stored in the authentication server 15.

FIG. 17 is a block diagram illustrating a configuration example of the Wi-Fi spot 14.

The Wi-Fi spot 14 includes the IC card information acquisition unit 51, the authentication result notification unit 52, the wireless communication unit 53, an Internet communication unit 54, a wired communication unit 55, a CPU 56, and a bus 57.

The IC card information acquisition unit 51 acquires the card identification number of the IC card 16 issued by the IC card issuing machine 13. The IC card information acquisition unit 51 includes the touch frame portion 51A (see FIG. 4) and a short-range wireless communication unit (not illustrated). The touch frame portion 51A is a portion over which the user holds the IC card 16. The short-range wireless communication unit performs short-range wireless communication based on NFC with the IC card 16. When the user holds the IC card 16 over the touch frame portion 51A, the IC card information acquisition unit 51 acquires the card identification number of the IC card 16 by the short-range wireless communication between the IC card 16 and the short-range wireless communication unit.

The authentication result notification unit 52 includes the indicator (annunciator) and notifies the user of the authentication result (success or failure) from the authentication server 15 by lighting, color, or the like of the indicator.

The wireless communication unit 53 performs wireless communication based on Wi-Fi connection with the terminal 12. The wireless communication unit 53 permits the Wi-Fi connection with the terminal 12 indicated by the terminal information transmitted together with the notification of the authentication success from the authentication server 15. When the user operates the terminal 12 to select the SSID of the Wi-Fi spot 14 in the Wi-Fi connection setting of the network settings, the Wi-Fi connection between the terminal 12 and the wireless communication unit 53 is established.

The Internet communication unit 54 is connected to a communication line connected to the Internet, acquires, from the bus 57, data to be transmitted to the Internet (to a device connected to the Internet) from the terminal 12 with which the wireless communication unit 53 establishes the Wi-Fi connection, and transmits the data to the Internet. Furthermore, the Internet communication unit 54 transmits the data to be transmitted from the Internet to the terminal 12 from the bus 57 to the wireless communication unit 53, and causes the wireless communication unit 53 to transmit the data to the terminal 12.

The wired communication unit 55 performs wired communication with the authentication server 15 through a dedicated line or the like.

The CPU 56 executes a program recorded in a ROM (not illustrated), a magnetic disk, or a non-volatile storage unit (not illustrated), thereby executing overall processing in the Wi-Fi spot 14. Furthermore, the CPU 56 gives a command to each of the IC card information acquisition unit 51, the authentication result notification unit 52, the wireless communication unit 53, the Internet communication unit 54, and the wired communication unit 55 via the bus 57 to control the operation of each unit, and exchanges various types of data via the bus 57.

The bus 57 connects the IC card information acquisition unit 51, the authentication result notification unit 52, the wireless communication unit 53, the Internet communication unit 54, the wired communication unit 55, and the CPU 56 to each other, and transmits various types of data.

<Processing Related to User Interface at Start of Use of Public Wireless LAN>

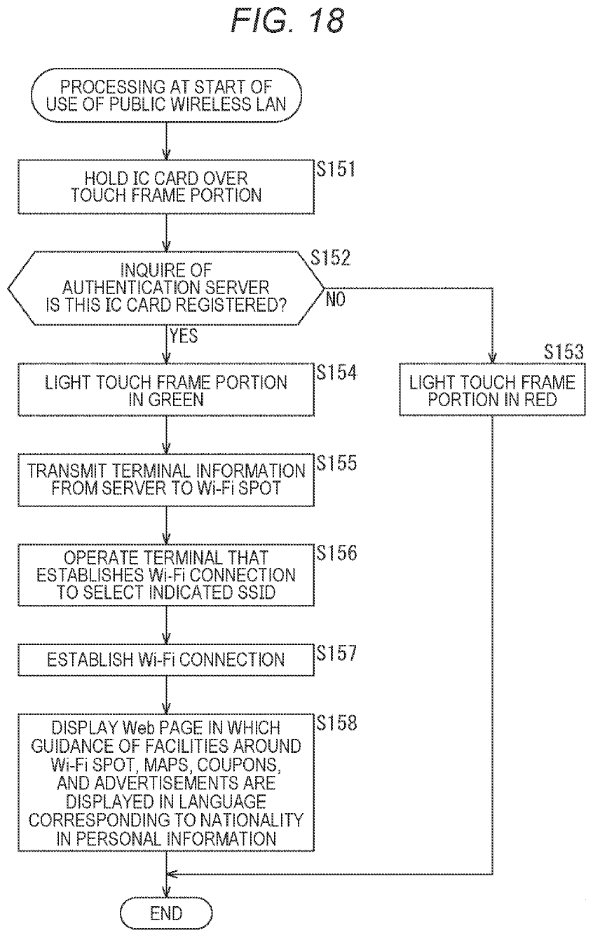

FIG. 18 is a flowchart for describing an example of processing related to a user interface of the Wi-Fi spot 14 in FIG. 17 at the start of use of the public wireless LAN.

In step S151, the user holds the IC card 16 issued by the IC card issuing machine 13 over the touch frame portion 51A of the Wi-Fi spot 14. The CPU 56 of the Wi-Fi spot 14 acquires the card identification number of the IC card 16 by the IC card information acquisition unit 51. The processing proceeds from step S151 to step S152.

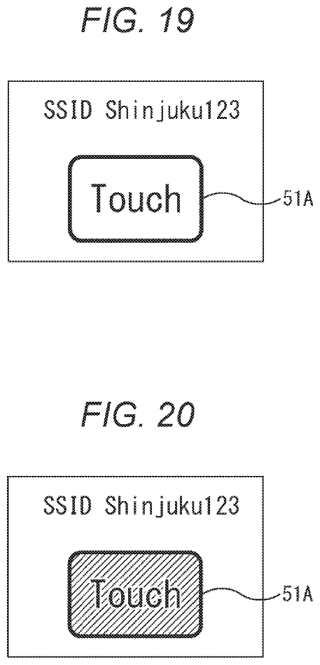

FIG. 19 is a diagram exemplifying the touch frame portion 51A over which the user holds the IC card 16 in step S151. In FIG. 19, the touch frame portion 51A is provided on a housing surface of the Wi-Fi spot 14. On the touch frame portion 51A, characters “Touch” are indicated. Furthermore, near the touch frame portion 51A, there is attached a notation label of, for example, “SSID: Shinjuku123”, which indicates the network name (SSID) for Wi-Fi connection with the Wi-Fi spot 14.

In step S152, the CPU 56 transmits the card identification number of the IC card 16 acquired from the IC card information acquisition unit 51 to the authentication server 15 by communication between the wired communication unit 55 and the authentication server 15, and inquires whether the card identification number of the IC card 16 is registered as the user information. The authentication server 15 searches the user information for the card identification number from the Wi-Fi spot 14. The authentication server 15 then transmits, to the Wi-Fi spot 14, the result of whether or not the card identification number from the Wi-Fi spot 14 is present in the user information.

In a case where the card identification number of the IC card 16 of the user is registered as the user information according to the result from the authentication server 15 (in a case where the user is authenticated), the processing in the CPU 56 of the Wi-Fi spot 14 proceeds from step S152 to step S154. In a case where the card identification number of the IC card 16 of the user is not registered as the user information (in a case where the user is not authenticated), the processing proceeds from step S152 to step S153.

In step S153, the CPU 56 causes the authentication result notification unit 52 to light the touch frame portion 51A in red. The processing skips steps S154 to S158 and ends.

In step S154, the CPU 56 causes the authentication result notification unit 52 to light the touch frame portion 51A in green. The processing proceeds from step S154 to step S155.

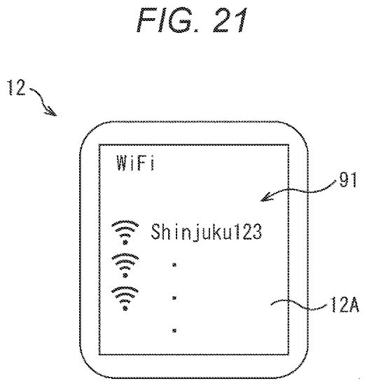

FIG. 20 is a diagram exemplifying the touch frame portion 51A lit in green in step S154. In FIG. 20, the touch frame portion 51A is lit in green by a backlight of the authentication result notification unit 52. Note that the authentication result notification unit 52 may include a speaker and output a sound (voice or the like) from the speaker in a case where the user has been authenticated or in a case where the user has not been authenticated.

In step S155, the personal information and the terminal information associated with the card identification number of the IC card 16 are transmitted from the authentication server 15 to the Wi-Fi spot 14. The CPU 56 acquires the personal information and the terminal information from the authentication server 15 via the wired communication unit 55. The processing proceeds from step S155 to step S156.

In step S156, the user operates the terminal 12 to select, as a connection destination, the SSID (Shinjuku123) indicated near the touch frame portion 51A in FIGS. 19 and 20 in the Wi-Fi connection setting of the network settings. The wireless communication unit 53 of the Wi-Fi spot 14 receives the request for Wi-Fi connection from the terminal 12. The processing proceeds from step S156 to step S157.

FIG. 21 is a diagram exemplifying a Wi-Fi connection setting screen displayed on the display 12A of the terminal 12 in step S156. In FIG. 21, a Wi-Fi connection setting screen 96 displays a list of network names (SSIDs) of beacons received by the terminal 12. The user selects, from the list, the SSID (Shinjuku123), which is indicated near the touch frame portion 51A, as the connection destination. Since the SSID is indicated near the touch frame portion 51A, a risk that the user may erroneously select a different SSID to connect to an unexpected Wi-Fi spot is reduced.

In step S157, the CPU 56 permits the terminal 12 indicated by the terminal information acquired from the authentication server 15 in step S156 to establish the Wi-Fi connection with the wireless communication unit 53. As a result, the wireless communication unit 53 establishes the Wi-Fi connection in response to the request for the Wi-Fi connection, which has been received from the terminal 12 in step S157. The terminal 12 then establishes the Wi-Fi connection with the wireless communication unit 53 of the Wi-Fi spot 14, the wireless communication unit 53 is connected to the Internet communication unit 54 via the bus 57, and the Internet communication unit 54 is connected to the Internet, so that the terminal 12 is connected to the Internet via the Wi-Fi connection, which enables the terminal 12 to use the public wireless LAN. The processing proceeds from step S157 to step S158.

In step S158, the CPU 56 transmits a web page for displaying the information screen 61 illustrated in FIG. 6 from the wireless communication unit 53 to the terminal 12. The display 12A of the terminal 12 displays the information screen 61 exemplified in FIG. 6.

Furthermore, the CPU 56 generates the web page in a language corresponding to the nationality included in the personal information acquired from the authentication server 15 in step S156, and causes the display 12A of the terminal 12 to display the web page. Moreover, as described with reference to FIG. 6, the CPU 56 causes the display 12A of the terminal 12 to display information such as guidance of facilities around the Wi-Fi spot 14, maps, coupons, and advertisements as the information screen 61.

Thus, the processing of starting using the public wireless LAN ends.

According to the Wi-Fi spot 14, substantially all terminals 12 can perform seamless connection setting while maintaining security equal to or higher than that of a network environment in which Wi-Fi connection is locked with a password. Furthermore, it is possible to present, to the user, a map of the surrounding area, information regarding restaurants and cafes, coupons, advertisements, and the like according to the language and preferences of the user on the basis of the personal information associated with the IC card 16, and to utilize the data stored in the authentication server 15 as big data. Thus, the provision of information utilizing personal information can provide a profit effect not only for the user but also for an operator that has installed the Wi-Fi spot 14.

<Configuration Example of Authentication Server>

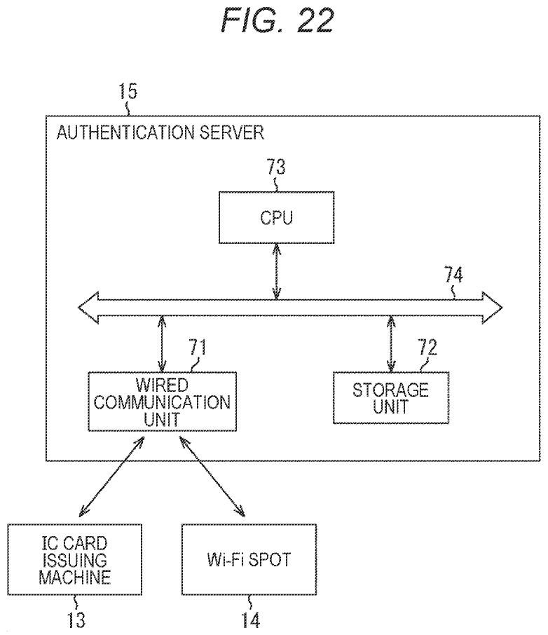

FIG. 22 is a block diagram for describing a configuration example of the authentication server 15.

In FIG. 22, the authentication server 15 includes a wired communication unit 71, a storage unit 72, a CPU 73, and a bus 74.

The wired communication unit 71 performs wired communication with the IC card issuing machines 13 and the Wi-Fi spots 14 through a dedicated line or the like.

The storage unit 72 stores the personal information, the terminal information, and the card identification number from each of the IC card issuing machines 13 as the user information. Furthermore, the storage unit 72 stores the use history information indicating the cumulative number of terminals with which each of the Wi-Fi spots 14 installed in the plurality of places establishes Wi-Fi connection. In addition, the storage unit 72 stores the blacklist, which is a list of persons who are prohibited from issuing the IC card 16 (using the public wireless LAN).

The CPU 73 executes a program recorded in a read only memory (ROM) (not illustrated), a magnetic disk, or the non-volatile storage unit 72, thereby executing overall processing in the authentication server 15. Furthermore, the CPU 73 gives a command to each of the wired communication unit 71 and the storage unit 72 via the bus 74 to control the operation of each unit, and exchanges various types of data via the bus 74.

The bus 74 connects the wired communication unit 71, the storage unit 72, and the CPU 73 to each other, and transmits various types of data.

<Processing of Authentication Server>

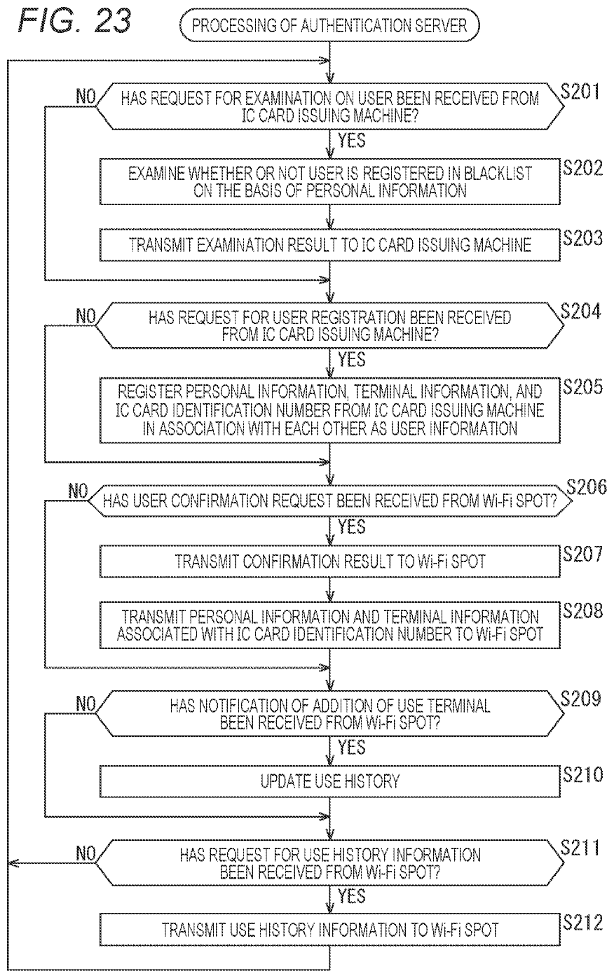

FIG. 23 is a flowchart for describing an example of processing of the authentication server 15.

In step S201, the CPU 73 determines whether or not the authentication server 15 has received, from one of the IC card issuing machines 13, a request for an examination on the user (user examination request) who applies for issuance of the IC card 16 (use of the public wireless LAN) to the IC card issuing machine 13.

In a case where it is determined in step S201 that the user examination request has not been received, the processing skips steps S201 to S203 and proceeds to step S204.

In a case where it is determined in step S201 that the user examination request has been received, the processing proceeds to step S202, and the CPU 73 examines whether or not the user is registered in the blacklist in the storage unit 72 (searches the blacklist for the user) on the basis of the personal information acquired from the passport 21 of the user and given from the IC card issuing machine 13. The processing proceeds from step S202 to step S203.

In step S203, the CPU 73 transmits the examination result in step S202 from the wired communication unit 71 to the IC card issuing machine 13. The processing proceeds from step S203 to step S204. The IC card issuing machine 13 can prevent a cyberattack in advance by not issuing the IC card 16 in a case where the user is registered in the blacklist according to the examination result from the authentication server 15.

In step S204, the CPU 73 determines whether or not a request for user registration (user registration request) has been received from the IC card issuing machine 13.

In a case where it is determined in step S204 that the user registration request has not been received, the processing skips step S205 and proceeds to step S206.

In a case where it is determined in step S204 that the user registration request has been received, the processing proceeds to step S205, and the CPU 73 registers the personal information, the terminal information, and the card identification number from the IC card issuing machine 13 in the storage unit 72 in association with each other as the user information. The processing proceeds from step S205 to step S206.

In step S206, the CPU 73 determines whether or not a request for confirming (user confirmation request) whether or not the card identification number is registered as the user information has been received from one of the Wi-Fi spots 14.

In a case where it is determined in step S206 that the user confirmation request has not been received, the processing skips steps S207 and S208 and proceeds to step S209.

In a case where it is determined in step S206 that the user confirmation request has been received, the processing proceeds to step S207, and the CPU 73 detects whether or not the card identification number received from the Wi-Fi spot 14 in step S206 is registered in the storage unit 72 as the user information. If the card identification number is registered as the user information, it is confirmed that the user is registered, and if the card identification number is not registered as the user information, it is confirmed that the user is not registered. The CPU 73 transmits the confirmation result to the Wi-Fi spot 14. The processing proceeds from step S207 to step S208.

In step S208, the CPU 73 extracts the personal information and the terminal information associated with the card identification number received from the Wi-Fi spot 14 in step S206 from the user information in the storage unit 72, and transmits the personal information and the terminal information to the Wi-Fi spot 14. The processing proceeds from step S208 to step S209. The Wi-Fi spot 14 permits the Wi-Fi connection of the terminal 12 indicated by the terminal information from the authentication server 15. However, in a case where it is confirmed in step S207 that the user is not registered, in step S208, the personal information and the terminal information are not transmitted to the Wi-Fi spot 14, and the user is not permitted to establish the Wi-Fi connection with the Wi-Fi spot 14.

In step S209, the CPU 73 determines whether or not a notification that the terminal 12 has newly established the Wi-Fi connection (notification of addition of a use terminal) has been received from the Wi-Fi spot 14.

In a case where it is determined in step S209 that the notification of addition of a use terminal has not been received, the processing skips step S210 and proceeds to step S211.

In a case where it is determined in step S209 that the notification of addition of a use terminal has been received, the processing proceeds to step S210, and the CPU 73 updates the use history information stored in the storage unit 72. That is, the use history information includes information regarding the cumulative number of terminals 12 with which each of the Wi-Fi spots 14 installed in the plurality of places has established Wi-Fi connection from the past to the present. Every time the notification of addition of a use terminal is received from one of the Wi-Fi spots 14, the CPU 73 updates the cumulative number in the use history information for the Wi-Fi spot 14 that has transmitted the notification of addition of a use terminal to the number obtained by adding one. The processing proceeds from step S210 to step S211.

Note that the use history information is stored as a database different from the user information in the storage unit 72. The use history information is, for example, information including position information, a use situation, and personal information of users regarding each of the Wi-Fi spots 14 in the plurality of places. When receiving the notification of addition of a use terminal (card identification number) from one of the Wi-Fi spots 14 in an arbitrary place, the CPU 73 updates the use history information.

In step S211, the CPU 73 determines whether or not a request for transmission of the use history information (use history information request) has been received from the Wi-Fi spot 14.

In a case where it is determined in step S211 that the use history information request has not been received, the processing returns to step S201 and repeats steps S201 to S212.

In a case where it is determined in step S211 that the use history information request has been received, the processing proceeds to step S212, and the CPU 73 reads the use history information from the storage unit 72 and transmits the read use history information to the Wi-Fi spot 14. Note that, on the information screen 61 illustrated in FIG. 6, the second information unit 63 related to the popular Wi-Fi spots is generated on the basis of the use history information. The processing returns from step S212 to step S201 and repeats steps S201 to S212.

Here, when the user information or the use history information is used as big data, the Wi-Fi spot 14 may perform analysis, or the authentication server 15 may perform analysis. Moreover, an external information device different from the Wi-Fi spot 14 and the authentication server 15 may acquire the user information (at least one of the personal information or the terminal information) and the use history information from the authentication server 15, and analyze and store the user information and the use history information. The user information and the use history information can be used as marketing information because the operator or the like that has installed the Wi-Fi spot 14 can grasp the tendency of the users of the Wi-Fi spot 14.

Furthermore, the authentication server 15 may determine the attribute of the user from the personal information associated with the card identification number when the user confirmation request is made from the Wi-Fi spot 14, and perform access control according to the attribute of the user when the user uses the public wireless LAN from the Wi-Fi spot 14. For example, in a case where the user is a cyber-attacker, an illegal resident, or a criminal, the authentication server 15 performs access control such as prohibition of Wi-Fi connection in the Wi-Fi spot 14 or restriction on a time when and a place (connection destination or the like) where the user uses the Internet. Such access control may be performed by the Wi-Fi spot 14 that has acquired information regarding the attribute of the user from the authentication server 15. The access control is performed according to the attribute of the user, and thus a cyberattack is suppressed.

Furthermore, in a case where an elapsed time from when the user held the IC card 16 over the touch frame portion 51A of one of the Wi-Fi spots 14 in a predetermined place (or from when the user confirmation request was made from the Wi-Fi spot 14 to the authentication server 15) exceeds a predetermined limit time, the authentication server 15 may cause the Wi-Fi spot 14 to disconnect the Wi-Fi connection with the terminal 12 of the user (stop the user using the public wireless LAN). The limit time of Wi-Fi connection may be set according to, for example, the installation place of the Wi-Fi spot 14 or a time zone in which the Wi-Fi spot 14 is used. Such restriction on Wi-Fi connection may be performed by the Wi-Fi spot 14 instead of the authentication server 15. With such restriction, a cyberattack is suppressed.

Furthermore, the Wi-Fi spot 14 may be used for a fee depending on the installation place or the like. For example, a Wi-Fi spot 14 in a place where installation work or maintenance is difficult, such as at the top of Mt. Fuji, is used for a fee. In this case, the authentication server 15 or the Wi-Fi spot 14 performs charging processing. The operator can obtain additional benefits.

According to the first embodiment of the information processing system described above, the personal information of the user and the terminal information of the terminal 12 are associated with each other, so that it is possible to prevent connection of an unspecified user, and thus it is possible to suppress a cyberattack by a malicious user.

Furthermore, since the user can easily visually recognize which of the Wi-Fi spots 14 to connect to, the risk of erroneously connecting to a different Wi-Fi spot is reduced.

In addition, it is not necessary to perform redundant operations such as input of an ID and a password or make preparations such as pre-registration before entry into the country.

Furthermore, almost all terminals can be connected to the Wi-Fi spots 14, and all users who have an IC card such as a Suica (registered trademark), which include even foreigners visiting Japan, can use the Wi-Fi spots 14.

In addition, even if the IC card 16 is lost, leakage of the personal information is prevented because the data is managed by the authentication server 15.

### Second Embodiment of Information Processing System

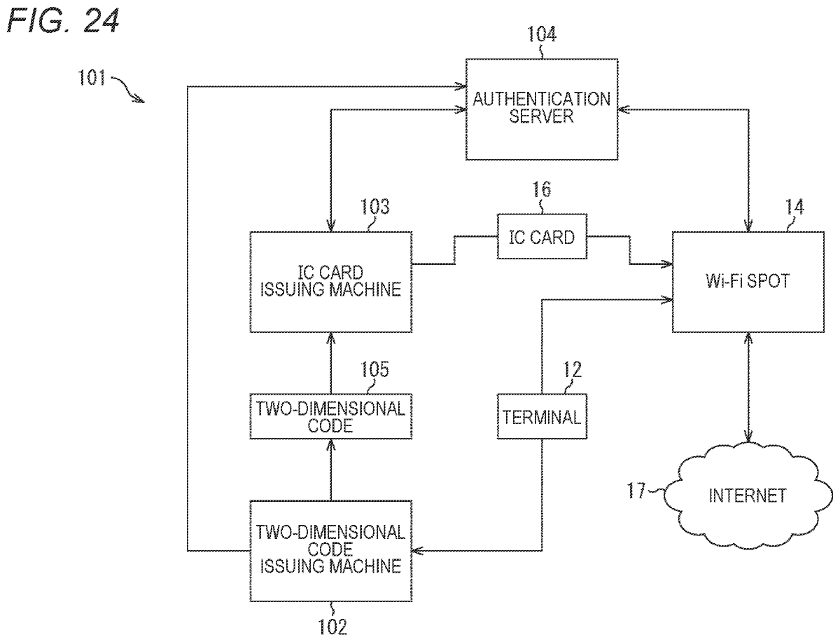

FIG. 24 is a block diagram illustrating a schematic configuration example of a second embodiment of the information processing system to which the present technology is applied. Note that, in the drawing, portions corresponding to those of the information processing system 11 in FIG. 1 are denoted by the same reference signs, and description thereof will be omitted.

An information processing system 101 in FIG. 24 includes a terminal 12, Wi-Fi spots 14, an IC card 16, a two-dimensional code issuing machine 102 as an information processing device, IC card issuing machines 103 as information processing devices, and an authentication server 104 as a server device. Therefore, the information processing system 101 in FIG. 24 is common to the case of FIG. 1 in including the terminal 12, the Wi-Fi spots 14, and the IC card 16. However, the information processing system 101 in FIG. 24 is different from the case of FIG. 1 in that the IC card issuing machines 103 and the authentication server 104 are provided instead of the IC card issuing machines 13 and the authentication server 15 in FIG. 1, and the two-dimensional code issuing machine 102 is newly provided.

The two-dimensional code issuing machine 102 is installed, for example, at an airport or the like in the home country of a traveler from overseas. The two-dimensional code issuing machine 102 issues a two-dimensional code 105 for issuance of the IC card 16 for an owner of the terminal 12 to use a public wireless LAN. The two-dimensional code is, for example, a QR code (registered trademark). Note that the two-dimensional code 105 represents a two-dimensional code printed on a sheet or an image of a two-dimensional code captured by the terminal 12 or the like and displayed on a display. When issuing the two-dimensional code 105, the two-dimensional code issuing machine 102 acquires personal information for specifying a user and terminal information for specifying the terminal 12 used by the user.

Furthermore, the two-dimensional code issuing machine 102 associates the acquired personal information and terminal information of the user with identification information represented by the two-dimensional code 105 issued to the user (referred to as code information), and causes the authentication server 104 to register the associated information as user information.

The IC card issuing machines 103 are installed in a plurality of places such as domestic airports and stations. Each of the IC card issuing machines 103 issues the IC card 16 for the owner of the terminal 12 to use the public wireless LAN. When issuing the IC card 16, the IC card issuing machine 103 acquires the code information of the two-dimensional code 105 acquired in advance by the user using the two-dimensional code issuing machine 102.

The IC card issuing machine 103 transmits the acquired code information to the authentication server 104, confirms that the code information is registered as the user information, and issues the IC card 16.

Furthermore, the IC card issuing machine 103 transmits the card identification number of the IC card 16 issued to the user to the authentication server 104, and additionally registers the card identification number as the user information in association with the personal information, the terminal information, and the code information of the user, which have already been registered as the user information. Note that the authentication server 104 may delete the code information and register the card identification number of the IC card 16 instead of the code information.

The authentication server 104 is connected to the two-dimensional code issuing machine 102, the IC card issuing machines 103, and the Wi-Fi spots 14 via a communication line. The authentication server 104 stores (registers) the personal information and the terminal information of the user and the code information, which are supplied from the two-dimensional code issuing machine 102 when the two-dimensional code 105 is issued, in association with each other as the user information.

Furthermore, the authentication server 104 additionally registers, as the user information, the card identification number of the IC card 16, which is supplied from one of the IC card issuing machines 103 when the IC card 16 is issued by the IC card issuing machine 103, in association with the personal information, the terminal information, and the code information of the user, which have already been registered as the user information.

Furthermore, when the card identification number acquired from the IC card 16 of the user is given by one of the Wi-Fi spots 14, the authentication server 104 collates the card identification number from the Wi-Fi spot 14 with the user information registered in advance. The authentication server 104 then extracts, from the user information, the terminal information associated with the card identification number from the Wi-Fi spot 14, and transmits the extracted terminal information to the Wi-Fi spot 14.

<Flow of Processing at the Time of Issuing Two-Dimensional Code>

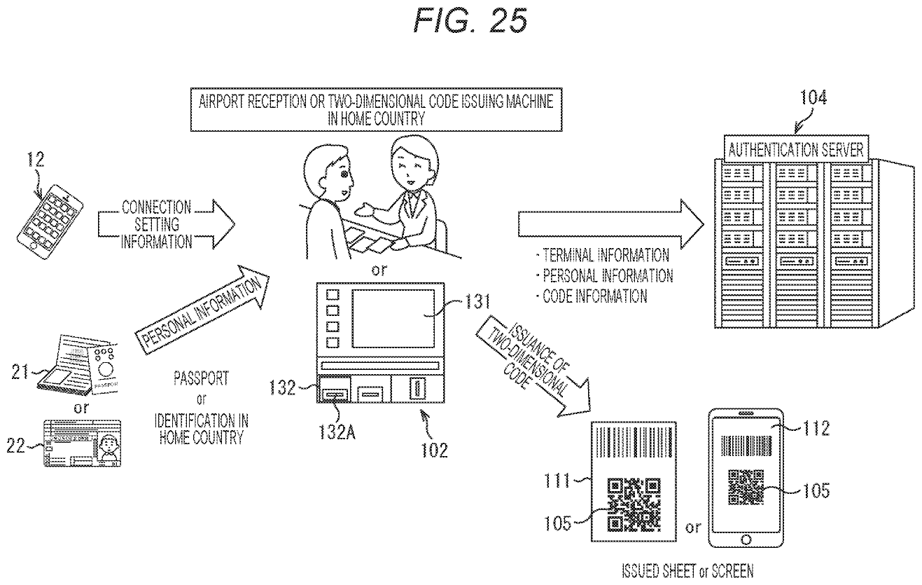

FIG. 25 is a diagram for describing a flow of processing at the time of issuing the two-dimensional code.

In FIG. 25, the two-dimensional code issuing machine 102 is installed at an airport or the like in the home country of a traveler from overseas. Furthermore, in FIG. 25, it is shown that the procedure of issuing the two-dimensional code may be performed without use of the two-dimensional code issuing machine 102 or by a person in charge of reception operating the two-dimensional code issuing machine 102 instead of the user.

The two-dimensional code issuing machine 102 acquires the personal information from an identification document of the user, such as a passport 21 or a driver's license 22, with which the user can be identified in his or her home country.

Furthermore, the two-dimensional code issuing machine 102 acquires the terminal information of the terminal 12 of the user.

Since a method by which the two-dimensional code issuing machine 102 acquires the personal information and the terminal information is the same as that of the IC card issuing machine 13 in FIG. 2 and the like, the description thereof will be omitted.

The two-dimensional code issuing machine 102 issues the two-dimensional code 105, which is unique code information for each user. For example, the two-dimensional code issuing machine 102 prints the two-dimensional code 105 on a sheet 111 and provides the sheet 111 to the user. Furthermore, for example, the two-dimensional code issuing machine 102 may display the two-dimensional code 105 on a display 131, cause the user to capture an image with the terminal 12 or the like (hereinafter, simply the terminal 12), and cause a display 131 of the terminal 12 to display a captured image 112 of the two-dimensional code 105.

In addition, when issuing the two-dimensional code 105, the two-dimensional code issuing machine 102 transmits the personal information of the user, the terminal information of the terminal 12, and the code information of the issued two-dimensional code 105 to the authentication server 104, and causes the authentication server 104 to register the personal information, the terminal information, and the code information in association with each other as the user information.

<Flow of Processing at the Time of Issuing IC Card Using Two-Dimensional Code>

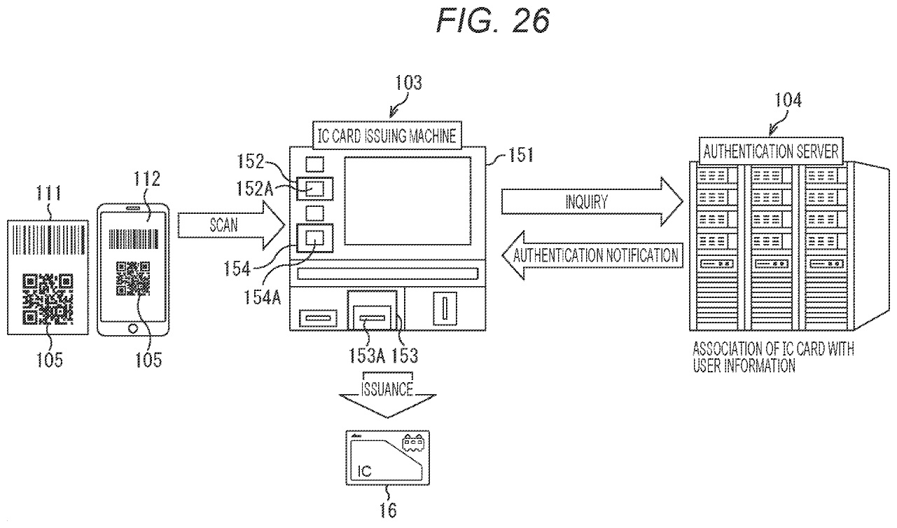

FIG. 26 is a diagram for describing a flow of processing at the time of issuing the IC card using the two-dimensional code.

In FIG. 26, the IC card issuing machine 103 is installed, for example, at an airport, a station, or the like in Japan. The IC card issuing machine 103 includes a two-dimensional code information acquisition unit 152 that captures an image of the two-dimensional code 105 and reads the code information. The user holds the two-dimensional code 105 issued by the two-dimensional code issuing machine 102 and printed on the sheet 111 over a scanning unit 152A of the two-dimensional code information acquisition unit 152. Alternatively, the user holds a screen displaying the captured image 112 of the two-dimensional code 105 issued by the two-dimensional code issuing machine 102, which has been captured by the terminal 12, over the scanning unit 152A of the two-dimensional code information acquisition unit 152. As a result, the two-dimensional code information acquisition unit 152 of the IC card issuing machine 103 acquires the code information from the two-dimensional code 105.

The IC card issuing machine 103 transmits the code information acquired by the two-dimensional code information acquisition unit 152 to the authentication server 104, and inquires whether or not the code information is registered as the user information.

The authentication server 104 searches the user information for the code information from the IC card issuing machine 103, and in a case where the corresponding code information is detected, the authentication server 104 authenticates validity of the code information and notifies the IC card issuing machine 103 of the validity.

When the notification of the authentication is obtained from the authentication server 104, the IC card issuing machine 103 sends out one unused IC card 16 from an IC card sending port 153A of an IC card issuing unit 153.

Furthermore, the IC card issuing machine 103 transmits the card identification number of the issued IC card 16 to the authentication server 104, and registers the card identification number as the user information in association with the personal information, the terminal information, and the code information of the user.

<Configuration Example of Two-Dimensional Code Issuing Machine>

FIG. 27 is a block diagram for describing a configuration example of the two-dimensional code issuing machine 102.

In FIG. 27, the two-dimensional code issuing machine 102 includes the display 131, a personal information acquisition unit 132, a terminal information acquisition unit 133, a two-dimensional code issuing unit 134, an operation input unit 135, a wired communication unit 136, a central processing unit (CPU) 137, and a bus 138.

In FIG. 27, the display 131 displays a guidance screen or the like for guiding the user who applies for use of the public wireless LAN to an operation of an application procedure.

The personal information acquisition unit 132 acquires, as the personal information, the passport number (passport number), the name, the nationality, the date of birth, the sex, the face photograph, or the like, which is information regarding identification matters recorded in the passport 21 of the user who applies for use of the public wireless LAN.

The terminal information acquisition unit 133 acquires the terminal information of the terminal 12 used when the user uses the public wireless LAN. The terminal information acquisition unit 133 includes a wireless communication unit (not illustrated) that operates as a wireless LAN access point, and acquires, from the terminal 12, a model name and a MAC address of the terminal 12, for example, as the terminal information by the wireless communication unit establishing Wi-Fi connection with the terminal 12.

The two-dimensional code issuing unit 134 prints the two-dimensional code 105 on a sheet and outputs the sheet from a sheet discharge port (not illustrated). Note that the CPU 137 also causes the display 131 to display the same two-dimensional code 105 as the two-dimensional code 105 issued by the two-dimensional code issuing unit 134. Note that the two-dimensional code issuing unit 134 may include a communication unit that performs short-range wireless communication with the terminal 12 or may use the wireless communication unit of the terminal information acquisition unit 133 to transmit the two-dimensional code 105 to the terminal 12 by communication with the terminal 12.

The operation input unit 135 detects a user operation on a touch panel provided on the display 131 or an operation button.

The wired communication unit 136 performs wired communication with the authentication server 104 through a dedicated line or the like.

The CPU 137 executes a program recorded in a read only memory (ROM) (not illustrated), a magnetic disk, or a non-volatile storage unit (not illustrated), thereby executing overall processing in the two-dimensional code issuing machine 102. Furthermore, the CPU 137 gives a command to each of the display 131, the personal information acquisition unit 132, the terminal information acquisition unit 133, the two-dimensional code issuing unit 134, the operation input unit 135, and the wired communication unit 136 via the bus 138 to control the operation of each unit, and exchanges various types of data via the bus 138.

The bus 138 connects the display 131, the personal information acquisition unit 132, the terminal information acquisition unit 133, the two-dimensional code issuing unit 134, the operation input unit 135, the wired communication unit 136, and the CPU 137 to each other, and transmits various types of data.

<Configuration Example of IC Card Issuing Machine Using Two-Dimensional Code>

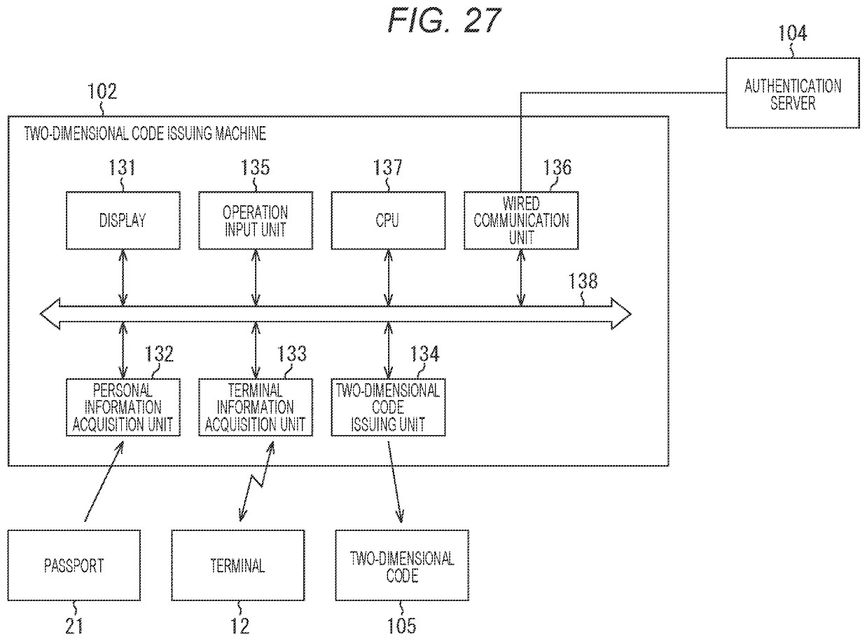

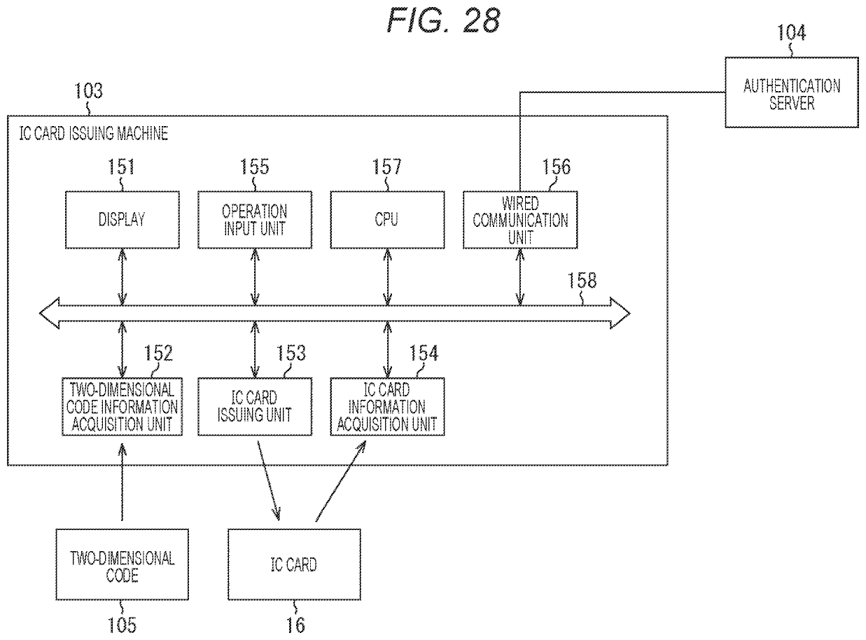

FIG. 28 is a block diagram for describing a configuration example of the IC card issuing machine 103 using the two-dimensional code.

In FIG. 28, the IC card issuing machine 103 includes a display 151, the two-dimensional code information acquisition unit 152, the IC card issuing unit 153, an IC card information acquisition unit 154, an operation input unit 155, a wired communication unit 156, a CPU 157, and a bus 158.

The display 151 displays a guidance screen or the like for guiding the user who applies for issuance of the IC card 16 to an operation of an application procedure.

The two-dimensional code information acquisition unit 152 includes the scanning unit 152A (see FIG. 26). The two-dimensional code information acquisition unit 152 captures an image of the two-dimensional code 105 printed on the sheet 111 or the two-dimensional code 105 displayed on the screen of the terminal 12 by the scanning unit 152A, and acquires the code information represented by the two-dimensional code 105.

The IC card issuing unit 153 takes out one IC card 16 from a storage portion (not illustrated) in which a large number of unused IC cards 16 are stored, and sends out the IC card 16 from the IC card sending port 153A (see FIG. 26).

In a case where, for example, a plurality of users uses the public wireless LAN with one IC card 16, the IC card information acquisition unit 154 acquires the card identification number of an already issued IC card 16. The IC card information acquisition unit 154 includes a touch frame portion (not illustrated) over which the user holds the IC card 16, and a short-range wireless communication unit (not illustrated) that performs short-range wireless communication based on NFC with the IC card 16. When the user holds the already issued IC card 16 over the touch frame portion, the IC card information acquisition unit 154 acquires the card identification number of the IC card 16 by the short-range wireless communication between the IC card 16 and the short-range wireless communication unit.

The operation input unit 155 detects a user operation on a touch panel provided on the display 151 or an operation button.

The wired communication unit 156 performs wired communication with the authentication server 104 through a dedicated line or the like.

The CPU 157 executes a program recorded in a read only memory (ROM) (not illustrated), a magnetic disk, or a non-volatile storage unit (not illustrated), thereby executing overall processing in the IC card issuing machine 103. Furthermore, the CPU 157 gives a command to each of the display 151, the two-dimensional code information acquisition unit 152, the IC card issuing unit 153, the IC card information acquisition unit 154, the operation input unit 155, and the wired communication unit 156 via the bus 158 to control the operation of each unit, and exchanges various types of data via the bus 158.

The bus 158 connects the display 151, the two-dimensional code information acquisition unit 152, the IC card issuing unit 153, the IC card information acquisition unit 154, the operation input unit 155, the wired communication unit 156, and the CPU 157 to each other, and transmits various types of data.

<Processing Related to User Interface at the Time of Issuing Two-Dimensional Code>

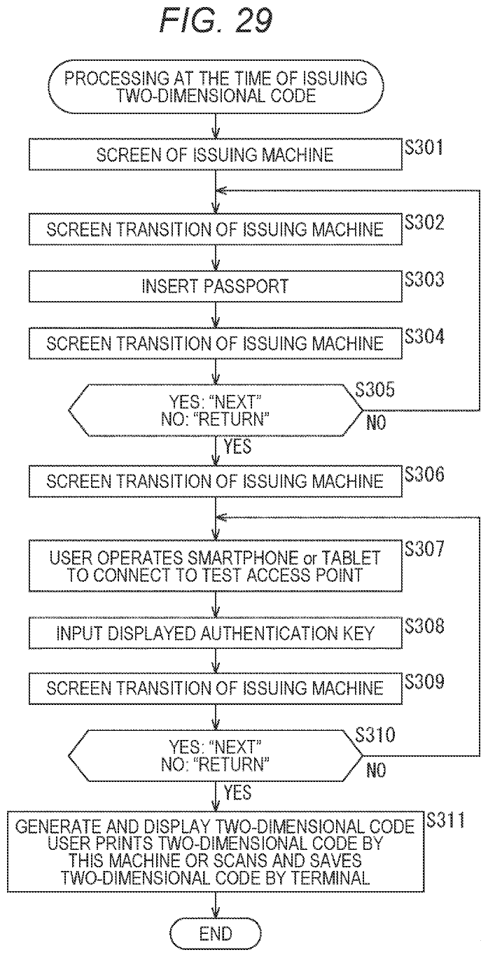

FIG. 29 is a flowchart for describing an example of processing related to a user interface of the two-dimensional code issuing machine 102 in FIG. 27 at the time of issuing the two-dimensional code.

In step S301, the CPU 137 causes the display 131 to display a start screen for starting creation of a new two-dimensional code. The processing proceeds from step S301 to step S302. Note that display of an initial screen for selecting a language and an operation on the initial screen are omitted, and the display 31 displays information in the language selected by the user. In the description of this flowchart, it is assumed that Japanese is selected. Furthermore, the display 131 may display information in a language of the country in which the two-dimensional code issuing machine 102 is installed.

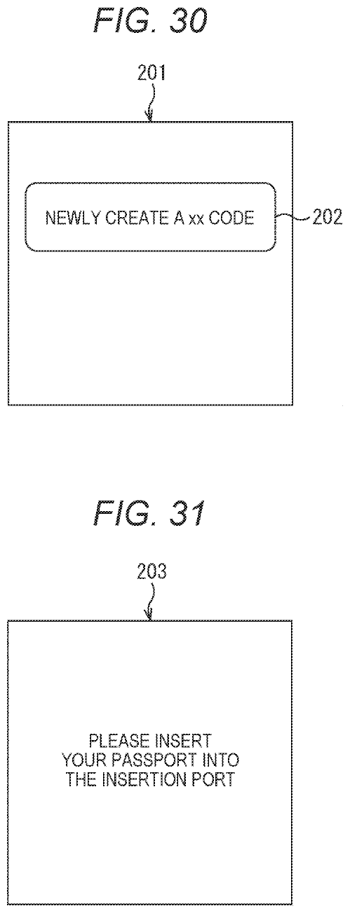

FIG. 30 is a diagram exemplifying the start screen displayed on the display 131 in step S301. In FIG. 30, a start screen 201 displays a button image 202. On the button image 202, character information “newly create a xx code” is displayed in a superimposed manner. The “xx code” represents the name of the two-dimensional code, and actually, for example, “QR code” (registered trademark) is displayed. The user touches the display position of the button image 202 on the start screen 201 to start the procedure of creating the two-dimensional code.

In step S302, the CPU 137 causes display 131 to display an induction screen for inducing the user to insert the passport 21 into a passport insertion port 132A (see FIG. 25) of the personal information acquisition unit 132. The processing proceeds from step S302 to step S303.

FIG. 31 is a diagram exemplifying the induction screen displayed on the display 131 in step S302. In FIG. 31, an induction screen 203 displays character information “please insert your passport into the insertion port.

In step S303, the user inserts the passport 21 into the passport insertion port 132A of the personal information acquisition unit 132. The CPU 137 acquires information such as the passport number, the name, the nationality, the date of birth, the sex, the face photograph, or the like, which is information regarding the identification matters of the passport 21, by the personal information acquisition unit 132. The processing proceeds from step S303 to step S304.

In step S304, the CPU 137 causes the display 131 to display a confirmation screen for the user to confirm the personal information acquired from the passport 21. The processing proceeds from step S304 to step S305. Note that the personal information may be acquired from another type of identification such as a driver's license instead of the passport 21.

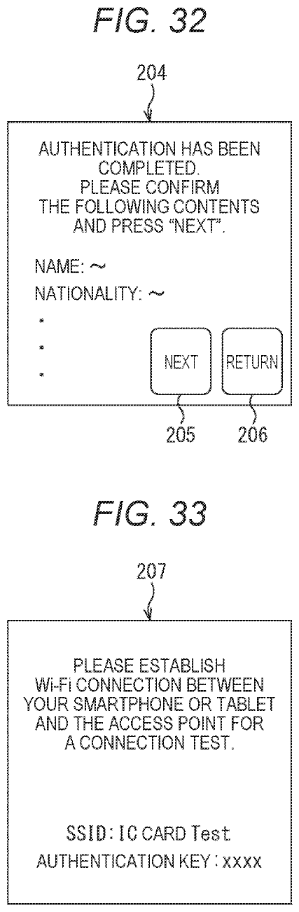

FIG. 32 is a diagram exemplifying the confirmation screen displayed on the display 131 in step S304. In FIG. 32, a confirmation screen 204 displays the contents of the personal information acquired in step S303. Furthermore, the confirmation screen 204 displays a first button image 205 and a second button image 206. On the first button image 205, character information “next” is displayed in a superimposed manner, and the user touches the position of the first button image 205 in a case where the personal information displayed on the confirmation screen 204 is correct. On the second button image 206, character information “return” is displayed in a superimposed manner, and the user touches the position of the second button image 206 in a case where the personal information displayed on the confirmation screen 204 is incorrect.

In step S305, the CPU 137 determines whether or not the personal information displayed on the confirmation screen 204 in FIG. 32 is correct on the basis of the user operation (touch position) obtained by the operation input unit 135.

In a case where it is determined in step S305 that the personal information displayed on the confirmation screen is incorrect (in a case where the position of the second button image 206 is touched), the processing returns from step S305 to step S302 and repeats steps S305 to S302.

On the other hand, in a case where it is determined in step S305 that the personal information displayed on the confirmation screen 204 in FIG. 32 is correct (in a case where the position of the first button image 205 is touched), the processing proceeds to step S306, and the CPU 137 causes the display 131 to display an induction image for inducing the user to cause the terminal 12 to establish Wi-Fi connection with the terminal information acquisition unit 133 operating as a test access point of the two-dimensional code issuing machine 102. The processing proceeds from step S306 to step S307.

FIG. 33 is a diagram exemplifying the induction screen displayed on the display 131 in step S306. In FIG. 33, an induction screen 207 displays character information “please establish Wi-Fi connection between your smartphone or tablet and the access point for a connection test”, which induces the user to establish the Wi-Fi connection with the terminal information acquisition unit 133 of the two-dimensional code issuing machine 102. Furthermore, the induction screen 207 displays, for example, character information “SSID: IC card Test”, which indicates the network name (SSID) of the terminal information acquisition unit 133 (the two-dimensional code issuing machine 102) as a connection destination to which the terminal 12 of the user establishes the Wi-Fi connection, and character information “authentication key: xxxx”, which indicates the authentication key.

In step S307, the user operates the terminal 12 to select the SSID (IC card Test) displayed on the induction screen 207 in FIG. 33 as the connection destination in a Wi-Fi connection setting of network settings. The terminal information acquisition unit 133 of the two-dimensional code issuing machine 102 receives a request for the Wi-Fi connection from the terminal 12. The processing proceeds from step S307 to step S308.

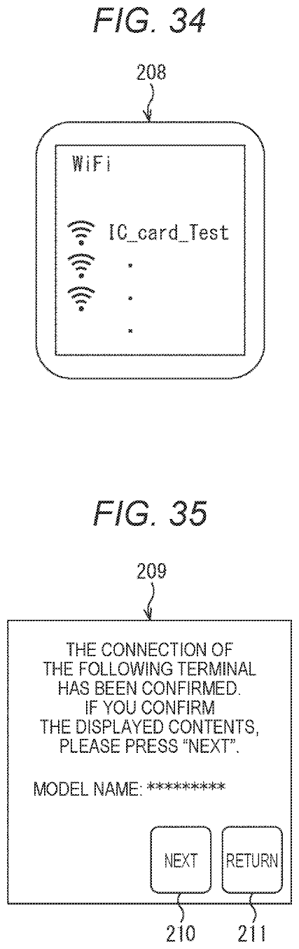

FIG. 34 is a diagram exemplifying a Wi-Fi connection setting screen displayed on the display of the terminal 12 in step S307. In FIG. 34, a Wi-Fi connection setting screen 208 displays a list of network names (SSID) of beacons received by the terminal 12. The user selects the SSID (IC card Test) of the terminal information acquisition unit 133 displayed on the induction screen 207 in FIG. 33 from the list.

In step S308, the user inputs the authentication key (xxxx) displayed on the induction screen 207 in FIG. 33 on a screen for inputting the authentication key, which is displayed on the display of the terminal 12 following the list. As a result, the Wi-Fi connection between the terminal 12 of the user and the terminal information acquisition unit 133 of the two-dimensional code issuing machine 102 is established. The terminal information acquisition unit 133 then acquires the model name and the MAC address of the terminal 12 as the terminal information by wireless communication via the Wi-Fi connection with the terminal 12, and supplies the terminal information to the CPU 38. The processing proceeds from step S308 to step S309.

In step S309, the CPU 137 causes the display 131 to display a confirmation screen for the user to confirm the terminal information acquired in step S308. The processing proceeds from step S309 to step S310.

FIG. 35 is a diagram exemplifying the confirmation screen displayed on the display 131 in step S309. In FIG. 35, a confirmation screen 209 displays the model name in the terminal information acquired in step S308. Furthermore, the confirmation screen 209 displays a first button image 210 and a second button image 211. On the first button image 210, character information “next” is displayed in a superimposed manner, and the user touches the position of the first button image 210 in a case where the model name displayed on the confirmation screen 209 is correct. On the second button image 211, character information “return” is displayed in a superimposed manner, and the user touches the position of the second button image 211 in a case where the personal information displayed on the confirmation screen 209 is incorrect.

In step S310, the CPU 137 determines whether or not the model name displayed on the confirmation screen 209 in FIG. 35 is correct on the basis of the user operation (touch position) obtained by the operation input unit 135.

In a case where it is determined in step S310 that the model name displayed on the confirmation screen 209 is incorrect (in a case where the position of the second button image 211 is touched), the processing returns from step S310 to step S307 and repeats steps S307 to S310.

On the other hand, in a case where it is determined in step S310 that the model name displayed on the confirmation screen 209 is correct (in a case where the position of the first button image 210 is touched), the processing proceeds to step S311, and the CPU 137 generates the two-dimensional code 105 and causes the display 131 to display the two-dimensional code 105. Furthermore, the CPU 137 causes the display 131 to display a notification screen indicating that the two-dimensional code 105 has been issued. Moreover, when an instruction to perform printing is made by a user operation (touch position) on the operation input unit 135, the CPU 137 causes the two-dimensional code issuing unit 134 to print the two-dimensional code 105 on a sheet and discharge the sheet from the sheet discharge port (not illustrated).

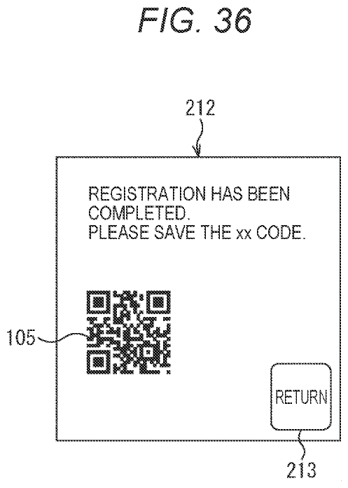

FIG. 36 is a diagram exemplifying a notification screen 212 (two-dimensional code issuance screen) displayed on the display 131 in step S311. In FIG. 36, the notification screen 212 displays character information “registration has been completed”, character information “please save the xx code”, the two-dimensional code 105, and a print button 213. The “xx code” represents the name of the two-dimensional code, and actually, for example, “QR code” (registered trademark) is displayed. The user may capture an image of the two-dimensional code 105 displayed on the display 131 with the terminal 12 or the like and save the two-dimensional code 105 as the captured image, or may touch the print button 213 to acquire the sheet on which the two-dimensional code 105 is printed.

Thus, the processing of issuing the two-dimensional code ends. As described above, the user can acquire the two-dimensional code 105 with a simple operation. Furthermore, the personal information of the user, the terminal information of the terminal 12 used by the user, and the code information of the two-dimensional code 105 issued to the user are registered in the authentication server 104 in association with each other. The user can register the personal information only by using the passport 21, and can register the terminal information of the terminal 12 only by wirelessly connecting the terminal 12 to the two-dimensional code issuing machine 102. In addition, even in a case where the sheet on which the two-dimensional code 105 is printed or the terminal 12 storing the captured image of the two-dimensional code 105 is lost, leakage of the personal information is prevented because the personal information and the like are stored in the authentication server 104.

<Processing Related to User Interface of IC Card Issuing Machine Using Two-Dimensional Code>

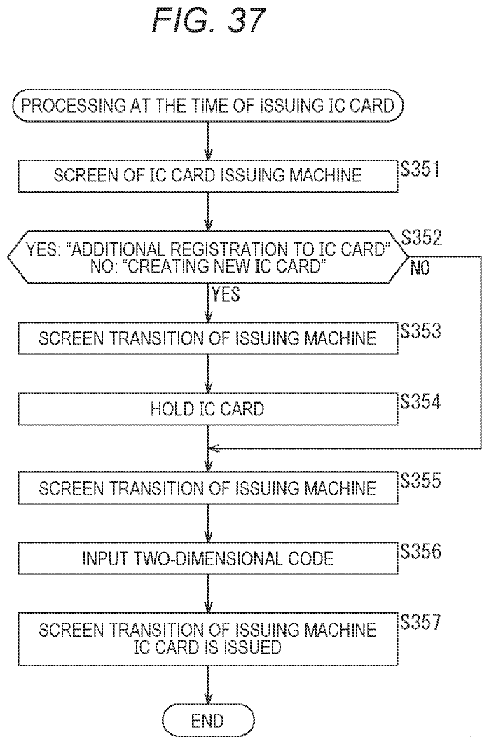

FIG. 37 is a flowchart for describing an example of processing related to a user interface of the IC card issuing machine 103 in FIG. 28 at the time of issuing the IC card.

In step S351, the CPU 157 causes the display 151 to display a selection screen on which the user selects either creating a new IC card or registering an additional user to his or her IC card (card identification number) (additional registration to the IC card). The processing proceeds from step S351 to step S352. Note that display of an initial screen for selecting a language and an operation on the initial screen are omitted, and the display 31 displays information in the language selected by the user. In the description of this flowchart, it is assumed that Japanese is selected.

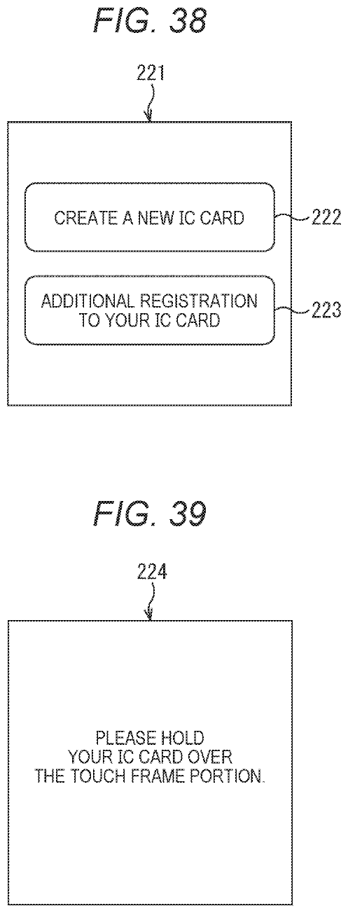

FIG. 38 is a diagram exemplifying the selection screen displayed on the display 151 in step S351. In FIG. 38, a selection screen 221 displays a first button image 222 and a second button image 223. On the first button image 222, character information “create a new IC card”, which is a first option, is displayed in a superimposed manner. On the second button image 223, display information of “additional registration to your IC card”, which is a second option, is displayed in a superimposed manner. The user touches the display position of the first button image 222 or the second button image 223 on the selection screen 221 to select either the first option or the second option.

Here, the second option is selected in a case where a plurality of users uses the public wireless LAN with one IC card 16 or in a case where one user uses a plurality of terminals 12. In a case where a family is traveling or a plurality of people is traveling together, the plurality of people or the plurality of terminals 12 can use the public wireless LAN with one IC card 16, and thus it is possible to reduce the time and effort for the procedure for starting using the public wireless LAN. In addition, the second option is selected also in a case where the user possesses the same type of IC card used in a system other than the information processing system to which the present technology is applied, and wants to use the IC card in the information processing system to which the present technology is applied.

In step S352, the CPU 157 determines which one of the first option and the second option has been selected on the basis of the user operation (touch position) obtained by the operation input unit 36.

In step S352, in a case where the user selects the first option, the processing skips steps S353 and S354 and proceeds to step S355.

On the other hand, in step S352, in a case where the user selects the second option, the processing proceeds to step S353, and the CPU 157 causes the display 151 to display an induction screen for inducing the user to hold the already issued IC card 16 over a touch frame portion 154A (see FIG. 26) of the IC card information acquisition unit 154. The processing proceeds from step S353 to step S354.

FIG. 39 is a diagram exemplifying the induction screen displayed on the display 151 in step S353. In FIG. 39, an induction screen 224 displays character information “please hold your IC card over the touch frame portion”.

In step S354, the user holds the IC card 16 over the touch frame portion 154A. The CPU 157 acquires the card identification number of the IC card 16 by the IC card information acquisition unit 154. The processing proceeds from step S354 to step S355.

In step S355, the CPU 157 causes the display 151 to display an induction screen for inducing the user to hold the two-dimensional code 105 issued by the two-dimensional code issuing machine 102 over the scanning unit 152A (see FIG. 26) of the two-dimensional code information acquisition unit 152. The processing proceeds from step S355 to step S356.

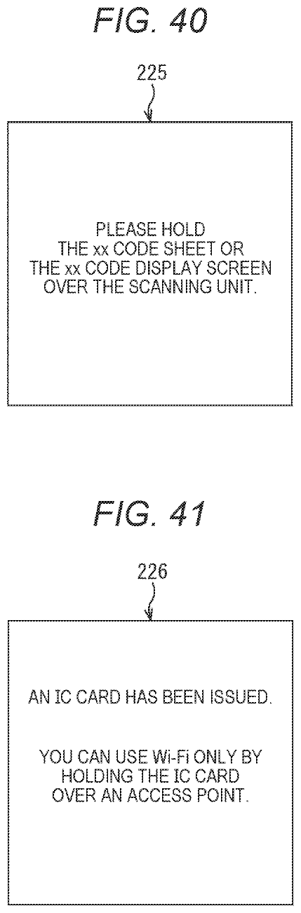

FIG. 40 is a diagram exemplifying the induction screen displayed on the display 151 in step S355. In FIG. 40, an induction screen 225 displays character information “please hold the xx code sheet or the xx code display screen over the scanning unit”. The “xx code” represents the name of the two-dimensional code, and actually, for example, “QR code” (registered trademark) is displayed.

In step S356, the user holds the sheet on which the two-dimensional code 105 acquired by the two-dimensional code issuing machine 102 is printed or the display screen of the terminal 12 or the like on which the captured image of the two-dimensional code 105 is displayed over the scanning unit 152A of the two-dimensional code information acquisition unit 152. The CPU 157 acquires the code information of the two-dimensional code 105 by the two-dimensional code information acquisition unit 152. The processing proceeds from step S356 to step S357.

In step S357, the CPU 157 causes the display 151 to display a notification screen indicating that the IC card 16 has been issued. Furthermore, the CPU 157 causes the IC card issuing unit 153 to send out the IC card 16 from the IC card sending port 153A (see FIG. 26).

FIG. 41 is a diagram exemplifying the notification screen displayed on the display 151 in step S357. In FIG. 41, a notification screen 226 displays character information “an IC card has been issued” and character information “you can use Wi-Fi only by holding the IC card over an access point”.

Note that, in a case where it is determined in step S352 that the second option has been selected, the new IC card 16 is not issued, and the card identification number of the IC card 16 acquired by the IC card information acquisition unit 154 is associated with the personal information and the terminal information of the user. Furthermore, a configuration may be adopted in which the IC card 16 is not issued in a case where an elapsed time from the acquisition of the code information in step S356 exceeds a predetermined limit time. In addition, a configuration may be adopted in which, in a case where it is determined in step S352 that the second option has been selected (in a case where the additional registration to the IC card is selected), the additional registration cannot be performed in a case where an elapsed time from when the personal information of the user was associated with the IC card 16 for the first time (when the personal information of the user was acquired for the first time) exceeds a predetermined limit time. This is to prevent another person from misusing the IC card 16 when the user loses the IC card 16. A configuration may also be adopted in which the IC card 16 is not issued even in a case where an elapsed time from when the two-dimensional code 105 was issued by the two-dimensional code issuing machine 102 exceeds a predetermined limit time.

Thus, the processing at the time of issuing the IC card ends. As described above, the user can acquire the IC card 16, and the personal information of the user, the terminal information of the terminal 12 used by the user, and the card identification number of the IC card 16 (or the handheld IC card 16) issued to the user are registered in the authentication server 104 in association with each other. The user can simply and quickly perform the procedure for issuing the IC card 16 only by using the two-dimensional code 105. Furthermore, even in a case where the user loses the IC card 16, leakage of the personal information is prevented because the personal information and the like are not stored in the IC card 16.

According to the second embodiment of the information processing system described above, the terminal information of the terminal 12 of the user and the personal information are associated with each other, so that it is possible to prevent connection of an unspecified user, and thus it is possible to suppress a cyberattack by a malicious user.

Furthermore, since the user can easily visually recognize which of the Wi-Fi spots 14 to connect to, the risk of erroneously connecting to a different Wi-Fi spot is reduced.

In addition, it is not necessary to perform redundant operations such as input of an ID and a password.

Furthermore, almost all terminals can be connected to the Wi-Fi spots 14, and all users who have an IC card such as a Suica (registered trademark), which include even foreigners visiting Japan, can use the Wi-Fi spots 14.

In addition, even if the IC card 16 is lost, leakage of the personal information is prevented because the data is managed by the authentication server 104.

Note that an information processing system may be adopted in which the IC card issuing machine 13 (see FIG. 1 and the like) in the first embodiment of the information processing system and the two-dimensional code issuing machine 102 and the IC card issuing machine 103 (see FIG. 24 and the like) in the second embodiment of the information processing system are mixed. Furthermore, an IC card issuing machine having functions of both the IC card issuing machine 13 in the first embodiment of the information processing system and the IC card issuing machine 103 in the second embodiment of the information processing system, that is, an IC card issuing machine having a function of acquiring the personal information and the terminal information of the user and issuing the IC card 16 and a function of acquiring the code information of the two-dimensional code 105 and issuing the IC card 16 may be used instead of the IC card issuing machine 103 in the second embodiment of the information processing system.

Furthermore, in the second embodiment of the information processing system, in a case where one of the Wi-Fi spots 14 acquires the code information from the two-dimensional code 105 issued by the two-dimensional code issuing machine 102 as the identification information, and the personal information and the terminal information associated with the code information are registered as the user information in the authentication server 104, the terminal indicated by the terminal information associated with the code information may establish Wi-Fi connection with the Wi-Fi spot 14. In this case, the IC card 16 is unnecessary.

<Program>

A part or all of the processing in each of the IC card issuing machines 13, the Wi-Fi spots 14, and the authentication server 15 in the information processing system 11 in FIG. 1 and a part or all of the series of processing in each of the two-dimensional code issuing machine 102, the IC card issuing machines 103, and the authentication server 104 in the information processing system 101 in FIG. 24 can be executed by hardware or software. In a case where a part or all of the series of processing is executed by software, programs constituting the software are installed in a computer. Here, the computer includes a computer incorporated in dedicated hardware, a general-purpose personal computer, for example, capable of executing various functions by installing various programs, and the like.

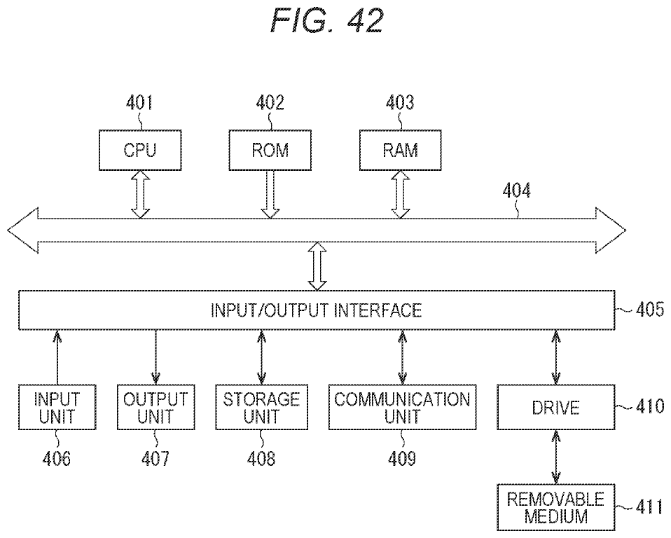

FIG. 42 is a block diagram illustrating a configuration example of hardware of the computer that executes the above-described series of processing by a program.

In the computer, a central processing unit (CPU) 401, a read only memory (ROM) 402, and a random access memory (RAM) 403 are connected to each other by a bus 404.

An input/output interface 405 is further connected to the bus 404. An input unit 406, an output unit 407, a storage unit 408, a communication unit 409, and a drive 410 are connected to the input/output interface 405.

The input unit 406 includes a keyboard, a mouse, a microphone, and the like. The output unit 407 includes a display, a speaker, and the like. The storage unit 408 includes a hard disk, a non-volatile memory, and the like. The communication unit 409 includes a network interface and the like. The drive 410 drives a removable medium 411 such as a magnetic disk, an optical disk, a magneto-optical disk, or a semiconductor memory.

In the computer configured as described above, for example, the CPU 401 loads a program stored in the storage unit 408 into the RAM 403 via the input/output interface 405 and the bus 404 and executes the program, thereby performing the above-described series of processing.

The program executed by the computer (the CPU 401) can be provided by being recorded in the removable medium 411 as a package medium or the like, for example. The program can also be provided via a wired or wireless transmission medium such as a local area network, the Internet, or digital satellite broadcasting.

The computer can install the program in the storage unit 408 via the input/output interface 405 by the removable medium 411 being attached to the drive 410. Furthermore, the program can be received by the communication unit 409 via the wired or wireless transmission medium and installed in the storage unit 408. In addition, the program can be installed in advance in the ROM 402 or the storage unit 408.

Note that the program executed by the computer may be a program in which processing is performed in time series in the order described in the present specification, or may be a program in which processing is performed in parallel or at a necessary timing such as when a call is made.

Note that the present technology may have the following configurations.

<1> An information processing device including:

a personal information acquisition unit configured to acquire personal information for specifying a user;

a terminal information acquisition unit configured to acquire terminal information for specifying a communication terminal used by the user;

an issuing unit configured to issue identification information or a medium storing the identification information; and

a communication unit configured to transmit the personal information, the terminal information, and the identification information to a server device.

<2> The information processing device according to <1>, in which

the issuing unit issues an IC card.

<3> The information processing device according to <1>, in which

the issuing unit issues a two-dimensional code.

<4> The information processing device according to any one of <1> to <3>, in which

the personal information acquisition unit acquires the personal information from an identification of the user.

<5> The information processing device according to any one of <1> to <4>, in which

the terminal information acquisition unit acquires the terminal information by communication with the communication terminal.

<6> The information processing device according to any one of <1> to <5>, in which

the terminal information acquisition unit acquires the terminal information by short-range wireless communication with the communication terminal.

<7> The information processing device according to <2>, in which

the IC card has an electronic money function or a boarding card function.

<8> The information processing device according to any one of <1> to <7>, in which

the issuance of the identification information or the medium by the issuing unit is limited by an elapsed time from the acquisition of the personal information by the personal information acquisition unit.

<9> The information processing device according to <2> or <7>, in which

the personal information acquisition unit acquires personal information of a plurality of users for one IC card.

<10> The information processing device according to any one of <1> to <9>, in which

the personal information acquisition unit acquires at least one of a passport number or a driver's license number of the user as the personal information.

<11> A server device including:

a user information storage unit configured to store personal information of a user, terminal information of a communication terminal used by the user, and identification information issued to the user in association with each other; and

a communication unit configured to communicate with an external information device, in which

the communication unit transmits at least one of the personal information or the terminal information in the user information storage unit to the external information device, the personal information and the terminal information being associated with the identification information given from the external information device.

<12> The server device according to <11>, in which

the external information device is a wireless communication access point.

<13> The server device according to <12>, further including

a use history information storage unit configured to store position information of the wireless communication access point, information regarding a use situation of the wireless communication access point, and the personal information when the identification information is given from the wireless communication access point.

<14> The server device according to <12> or <13>, which

limits a use time of the wireless communication access point.

<15> The server device according to any one of <12> to <14>, which

performs access control on a user of the wireless communication access point on the basis of an attribute of the user.

<16> An information terminal including:

an identification information acquisition unit configured to acquire identification information issued to a user;

a communication unit configured to transmit the identification information to a server device and to receive terminal information of a communication terminal of the user, the terminal information being associated with the identification information; and

a wireless communication unit configured to perform wireless communication with the communication terminal of the user by wireless connection on the basis of the terminal information.

<17> The information terminal according to <16>, in which

the communication unit receives personal information for specifying the user together with the terminal information.

<18> The information terminal according to <16> or <17>, in which

the identification information is identification information stored in an IC card.

<19> The information terminal according to <18>, in which

the identification information acquisition unit changes, according to a situation, a lighting color of a portion that acquires the identification information from the IC card and over which the IC card is held.

<20> An information processing system including:

a personal information acquisition unit configured to acquire personal information for specifying a user;

a terminal information acquisition unit configured to acquire terminal information for specifying a communication terminal used by the user;

an issuing unit configured to issue identification information or a medium storing the identification information;

a storage unit configured to store the personal information, the terminal information, and the identification information in association with each other;

an identification information acquisition unit configured to acquire the identification information issued by the issuing unit or the identification information stored in the medium issued by the issuing unit;

a terminal information acquisition unit configured to acquire, from the storage unit, the terminal information associated with the identification information acquired by the identification information acquisition unit; and

a communication unit configured to connect the communication terminal specified by the terminal information acquired by the terminal information acquisition unit to a network via wireless connection.

### REFERENCE SIGNS LIST

11, 101 Information processing system
12 Terminal
13 IC card issuing machine
14 Wi-Fi spot
15, 104 Authentication server
16 IC card
17 Internet
21 Passport
22 Driver's license
31 Display
32, 132 Personal information acquisition unit
33, 133 Terminal information acquisition unit
34, 103, 153 IC card issuing unit
35, 154 IC card information acquisition unit
36, 135, 155 Operation input unit
37, 71, 136 Wired communication unit
38, 56, 137, 157 CPU
51 IC card information acquisition unit
52 Authentication result notification unit
53 Wireless communication unit
54 Internet communication unit
55 Wired communication unit
72 Storage unit
102 Two-dimensional code issuing machine
132 Personal information acquisition unit
134 Two-dimensional code issuing unit
152 Two-dimensional code information acquisition unit

1. An information processing device comprising:
a personal information acquisition unit configured to acquire personal information for specifying a user;
a terminal information acquisition unit configured to acquire terminal information for specifying a communication terminal used by the user;
an issuing unit configured to issue identification information or a medium storing the identification information; and
a communication unit configured to transmit the personal information, the terminal information, and the identification information to a server device.

2. The information processing device according to claim 1, wherein
the issuing unit issues an IC card.

3. The information processing device according to claim 1, wherein
the issuing unit issues a two-dimensional code.

4. The information processing device according to claim 1, wherein
the personal information acquisition unit acquires the personal information from an identification of the user.

5. The information processing device according to claim 1, wherein
the terminal information acquisition unit acquires the terminal information by communication with the communication terminal.

6. The information processing device according to claim 1, wherein
the terminal information acquisition unit acquires the terminal information by short-range wireless communication with the communication terminal.

7. The information processing device according to claim 2, wherein
the IC card has an electronic money function or a boarding card function.

8. The information processing device according to claim 1, wherein
the issuance of the identification information or the medium by the issuing unit is limited by an elapsed time from the acquisition of the personal information by the personal information acquisition unit.

9. The information processing device according to claim 2, wherein
the personal information acquisition unit acquires personal information of a plurality of users for one IC card.

10. The information processing device according to claim 1, wherein
the personal information acquisition unit acquires at least one of a passport number or a driver's license number of the user as the personal information.

11. A server device comprising:
a user information storage unit configured to store personal information of a user, terminal information of a communication terminal used by the user, and identification information issued to the user in association with each other; and
a communication unit configured to communicate with an external information device, wherein
the communication unit transmits at least one of the personal information or the terminal information in the user information storage unit to the external information device, the personal information and the terminal information being associated with the identification information given from the external information device.

12. The server device according to claim 11, wherein
the external information device is a wireless communication access point.

13. The server device according to claim 12, further comprising
a use history information storage unit configured to store position information of the wireless communication access point, information regarding a use situation of the wireless communication access point, and the personal information when the identification information is given from the wireless communication access point.

14. The server device according to claim 12, which
limits a use time of the wireless communication access point.

15. The server device according to claim 12, which
performs access control on a user of the wireless communication access point on a basis of an attribute of the user.

16. An information terminal comprising:
an identification information acquisition unit configured to acquire identification information issued to a user;
a communication unit configured to transmit the identification information to a server device and to receive terminal information of a communication terminal of the user, the terminal information being associated with the identification information; and
a wireless communication unit configured to perform wireless communication with the communication terminal of the user by wireless connection on a basis of the terminal information.

17. The information terminal according to claim 16, wherein
the communication unit receives personal information for specifying the user together with the terminal information.

18. The information terminal according to claim 16, wherein
the identification information is identification information stored in an IC card.

19. The information terminal according to claim 18, wherein
the identification information acquisition unit changes, according to a situation, a lighting color of a portion that acquires the identification information from the IC card and over which the IC card is held.

20. An information processing system comprising:
a personal information acquisition unit configured to acquire personal information for specifying a user;
a terminal information acquisition unit configured to acquire terminal information for specifying a communication terminal used by the user;
an issuing unit configured to issue identification information or a medium storing the identification information;
a storage unit configured to store the personal information, the terminal information, and the identification information in association with each other;
an identification information acquisition unit configured to acquire the identification information issued by the issuing unit or the identification information stored in the medium issued by the issuing unit;
a terminal information acquisition unit configured to acquire, from the storage unit, the terminal information associated with the identification information acquired by the identification information acquisition unit; and
a communication unit configured to connect the communication terminal specified by the terminal information acquired by the terminal information acquisition unit to a network via wireless connection.
